(19) United States
(12) Patent Application Publication
(10) Pub. No.: US 2014/0177706 A1
(43) Pub. Date: Jun. 26, 2014

(54) METHOD AND SYSTEM FOR PROVIDING SUPER-RESOLUTION OF QUANTIZED IMAGES AND VIDEO

(71) Applicant: Samsung Electronics Co., LTD, Suwon-si (KR)

(72) Inventors: Felix C. Fernandes, Plano, TX (US); Esmaeil Faramarzi, Dallas, TX (US); Muhammad Salman Asif, Allen, TX (US); Zhan Ma, San Jose, CA (US)

(73) Assignee: Samsung Electronics Co., LTD, Suwon-si (KR)

(21) Appl. No.: 14/085,486

(22) Filed: Nov. 20, 2013

Related U.S. Application Data
(60) Provisional application No. 61/745,376, filed on Dec. 21, 2012.

(51) Int. Cl. G06T 3/40; H04N 19/124

(52) U.S. Cl. CPC G06T 3/4053; H04N 19/0009; G06T 3/4092
USPC 375/240.03

(57) ABSTRACT

An image-encoding system that is configured to generate an output stream based on an input image is provided that includes an encoder and a metadata extractor. The encoder is configured to encode a low-resolution image to generate a quantized, low-resolution image. The low-resolution image is generated based on the input image. The metadata extractor is configured to extract super-resolution (SR) metadata from the input image. The output stream comprises the quantized, low-resolution image and the SR metadata. An image-decoding system is configured to receive the output stream. The image-decoding system includes a decoder and an SR processor. The decoder is configured to decode the quantized, low-resolution image to generate a decoded image. The super-resolution processor is configured to perform super-resolution on the decoded image based on the SR metadata to generate a super-resolved image.

### CROSS-REFERENCE TO RELATED APPLICATION(S) AND CLAIM OF PRIORITY

The present application is related to U.S. Provisional Patent Application No. 61/745,376, filed Dec. 21, 2012, titled “METHOD FOR SUPER-RESOLUTION OF LOSSY COMPRESSED IMAGES AND VIDEO.” Provisional Patent Application No. 61/745,376 is assigned to the assignee of the present application and is hereby incorporated by reference into the present application as if fully set forth herein. The present application hereby claims priority under 35 U.S.C. §119(e) to U.S. Provisional Patent Application No. 61/745,376.

### TECHNICAL FIELD

The present application relates generally to image processing and, more specifically, to a method and system for providing super-resolution of quantized images and video.

### BACKGROUND

Super-resolution is the process of improving the resolution of either still images or video images. Generally, the images are compressed after being captured in order to reduce the amount of data to be stored and/or transmitted. Thus, super-resolution is typically performed on the compressed data or on the decompressed data recovered by a decoder. However, most currently-available super-resolution techniques are optimized for the original, uncompressed data and do not perform well when used on data that has been through a compression process.

### SUMMARY

This disclosure provides a method and system for providing super-resolution of quantized images or video.

In one embodiment, an image-encoding system that is configured to generate an output stream based on an input image is provided. The image-encoding system includes an encoder and a metadata extractor. The encoder is configured to encode a low-resolution image to generate a quantized, low-resolution image. The low-resolution image is generated based on the input image. The metadata extractor is configured to extract super-resolution (SR) metadata from the input image. The output stream comprises the quantized, low-resolution image and the SR metadata.

In another embodiment, a method for generating an output stream based on an input image is provided. The method includes encoding a low-resolution image to generate a quantized, low-resolution image. The low-resolution image is generated based on the input image. SR metadata is extracted from the input image. The output stream is generated based on the quantized, low-resolution image and the SR metadata.

In yet another embodiment, an image-decoding system that is configured to receive an output stream comprising a quantized, low-resolution image and SR metadata is provided. The quantized, low-resolution image is generated based on an input image, and the SR metadata is extracted from the input image. The image-decoding system includes a decoder and a super-resolution processor. The decoder is configured to decode the quantized, low-resolution image to generate a decoded image. The super-resolution processor is configured to perform super-resolution on the decoded image based on the SR metadata to generate a super-resolved image.

In still another embodiment, a method for providing super-resolution of quantized images is provided. The method includes receiving an output stream comprising a quantized, low-resolution image and SR metadata. The quantized, low-resolution image is generated based on an input image, and the SR metadata is extracted from the input image. The quantized, low-resolution image is decoded to generate a decoded image. Super-resolution is performed on the decoded image based on the SR metadata to generate a super-resolved image.

Before undertaking the DETAILED DESCRIPTION OF THE INVENTION below, it may be advantageous to set forth definitions of certain words and phrases used throughout this patent document: the term “image” includes still images or video images; the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a system for providing super-resolution of quantized images according to an embodiment of the disclosure;

FIG. 2A illustrates a system for processing a high-resolution video stream using the super-resolution process of FIG. 1 according to an embodiment of the disclosure;

FIG. 2B illustrates a system for generating a high-resolution video stream from a low-resolution video stream using the super-resolution process of FIG. 1 according to another embodiment of the disclosure;

FIG. 3 illustrates a system for providing super-resolution using optical flow metadata according to an embodiment of the disclosure;

FIG. 4 illustrates a process of generating the optical flow metadata of FIG. 3 according to an embodiment of the disclosure;

FIG. 5A illustrates frame-based insertion of an extended NALU header for use in the process of FIG. 3 according to an embodiment of the disclosure;

FIG. 5B illustrates frame-level super-resolution motion field encapsulation for use in the process of FIG. 3 according to an embodiment of the disclosure;

FIG. 6 illustrates a graphical representation of scattered data interpolation for use in providing super-resolution according to an embodiment of the disclosure;

FIG. 7 illustrates a process for providing super-resolution without using explicit motion estimation according to an embodiment of the disclosure;

FIG. 8 illustrates a process for providing blind super-resolution according to an embodiment of the disclosure;

FIG. 9 illustrates a process for providing super-resolution under photometric diversity according to an embodiment of the disclosure;

FIG. 10 illustrates a process for providing example-based super-resolution according to an embodiment of the disclosure;

FIG. 11 illustrates a system for providing super-resolution using patch indexing according to an embodiment of the disclosure;

FIG. 12 illustrates a process for providing database-free super-resolution according to an embodiment of the disclosure;

FIGS. 13A-C illustrate use of a tree-structured wavelet model for providing super-resolution according to an embodiment of the disclosure;

FIG. 14 illustrates a process for providing super-resolution using non-dyadic, interscale, wavelet patches according to an embodiment of the disclosure;

FIG. 15 illustrates edge profile enhancement for use in providing super-resolution according to an embodiment of the disclosure; and

FIG. 16 illustrates a process for providing super-resolution using a hallucination technique according to an embodiment of the disclosure.

### DETAILED DESCRIPTION

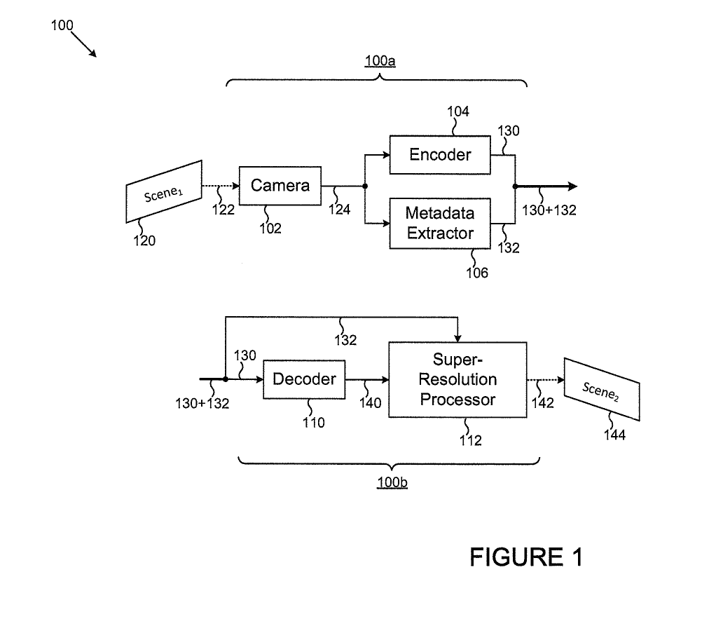

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged image processing system.

Image super-resolution (SR) is the process of estimating a high-resolution (HR) still image from one or a series of low-resolution (LR) still images degraded by various artifacts such as aliasing, blurring, noise, and compression error. Video SR, by contrast, is the process of estimating an HR video from one or more LR videos in order to increase the spatial and/or temporal resolution(s).

The spatial resolution of an imaging system depends on the spatial density of the detector (sensor) array and the point spread function (PSF) of the induced detector's blur. The temporal resolution, on the other hand, is influenced by the frame rate and exposure time of the camera. Spatial aliasing appears in still images or video frames when the cut-off frequency of the detector is lower than that of the lens. Temporal aliasing happens in video sequences when the frame rate of the camera is not high enough to capture high frequencies caused by fast moving objects. The blur in the captured images and videos is the overall effect of different sources such as defocus, motion blur, optical blur, and detector blur induced by light integration within the active area of each detector in the array.

There are four types of SR systems: single-image SR (SISR), multi-image SR (MISR), single-video SR (SVSR), and multi-video SR (MVSR). SISR techniques are known as learning-based, patch-based or example-based SR. For these techniques, small spatial patches (a patch is a group of pixels with an arbitrary shape) within a LR image are replaced by similar patches of higher resolution extracted from some other images. These techniques typically use an offline training phase to construct a database of HR patches and their corresponding LR patches.

MISR is the most common type of image SR method. This method leverages the information from multiple input images to reconstruct the output HR image. The most common MISR approaches are: 1) frequency-domain (PD), 2) non-uniform interpolation (NUI), 3) cost-function minimization (CFM), and 4) projection-onto-convex-sets (POCS). In practice, the MISR system is completely blind, i.e., the parameters of the system (such as motion (warping) vectors, blurring filters, noise characteristics, etc.) are unknown and should be estimated along with the output HR image.

SVSR methods are the generalization of either the SISR or the MISR methods to the case of video sequences. The former case (type I) is with the justification that small space-time patches within a video are repeated many times inside the same video or other videos at multiple spatio-temporal scales. In the latter case (type II), the spatial resolution is increased by combining each video frame with a few of its neighboring frames, or the temporal resolution is increased by estimating some intermediate frames between each two adjacent frames. In this disclosure, SISR and SVSR-type I are referred to as SFSR (single-frame SR) and MISR and SVSR-type II are referred to as MFSR (multi-frame SR).

MVSR methods are recent SR techniques with some unique characteristics such as: 1) no need for complex “inter-frame” alignments, 2) the potential of combining different space-time inputs, 3) the feasibility of producing different space-time outputs, and 4) the possibility of handling severe motion aliasing and motion blur without doing motion segmentation. For these methods, the 4D space-time motion parameters between the video sequences are estimated. For simplicity, all proposed MVSR methods are limited to the case that the spatial displacement is a 2D homography transformation and the temporal misalignment is a 1D affine transformation.

Although SR is beginning to be deployed in commercial products, this emerging technology possesses a practical limitation that results in suboptimal performance in many implementations. Specifically, most SR research has focused on the creation of HR content from pristine LR content that is free of lossy-compression artifacts. Unfortunately, most content that is viewed on consumer devices has undergone lossy compression to reduce storage space and/or bandwidth requirements. It is well known that this compression process introduces artifacts such as ringing, blockiness, banding and contouring. These artifacts reduce the quality of high-resolution content generated using super-resolution. Consequently, SR produces suboptimal results when implemented in consumer devices.

Some techniques have attempted to incorporate the compression process in the SR model, but they are limited to the use of estimated motions and/or prediction-error vectors computed by the encoder or the SR algorithm. Other techniques have tried to reduce the compression errors with post-processing operations. Also, it has been suggested that a pre-processing stage with downsampling and smoothing be added to the encoder and a post-processing stage with upsampling (using SR) be added to the decoder. The downsampling and smoothing filters are signaled to the decoder. Moreover, these techniques have only considered SR reconstruction from multiple frames. None of these techniques has comprehensively addressed the practical limitation that SR faces in consumer devices that typically use lossy compressed still images and/or video images.

FIG. 1 illustrates a system 100 for providing super-resolution of quantized images according to an embodiment of the disclosure. The system 100 shown in FIG. 1 is for illustration only. A system for providing super-resolution may be configured in any other suitable manner without departing from the scope of this disclosure.

The illustrated system 100 includes an image-encoding system 100a and an image-decoding system 100b. The image-encoding system 100a includes a camera 102, an encoder 104 and a metadata extractor 106. The image-decoding system 100b includes a decoder 110 and a super-resolution processor 112.

The camera 102 may be configured to capture still images and/or video images. For the illustrated example, the camera 102 is configured to capture an image 122 of an input scene 120 (Scene₁), to generate a digital image 124 of the input scene 120 based on the captured image 122, and to provide the digital image 124 to the encoder 104 and the metadata extractor 106. For some embodiments, the digital image 124 is downsampled before being provided to the encoder 104. In these embodiments, the metadata extractor 106 is configured to operate on the pre-downsampled image.

The encoder 104 is configured to encode the digital image 124 to generate a quantized image 130 of the input scene 120. The metadata extractor 106 is configured to extract metadata 132 from the digital image 124. The image-encoding system 100a is configured to output the quantized image 130 and the corresponding metadata 132.

The image-decoding system 100b is configured to receive the output 130 and 132 from the image-generating system 100a. The decoder 110 is configured to receive the quantized image 130 and to decode the quantized image 130 to generate a decoded image 140. The super-resolution processor 112 is configured to receive the metadata 132 and the decoded image 140 and to provide super-resolution of the decoded image 140 based on the metadata 132 to generate a super-resolved image 142. The super-resolved image 142 may be displayed as an output scene 144 (Scene₂). The output scene 144 may be displayed in any suitable manner, such as on a smartphone screen, a television, a computer or the like. By using metadata 132 extracted from the uncompressed digital image 124 in the super-resolution processor 112, the output scene 144 may be provided in a resolution similar to the input scene 120 or, for some embodiments, in a resolution higher than that of the input scene 120.

In operation, for some embodiments, the camera 102 captures an image 122 of an input scene 120 and generates an un-quantized digital image 124 of the input scene 120 based on the captured image 122. The camera 102 then provides the digital image 124 to the encoder 104 and the metadata extractor 106. The encoder 104 encodes the digital image 124, thereby generating a quantized image 130 of the input scene 120. The metadata extractor 106 extracts metadata 132 from the digital image 124. A decoder 110 receives and decodes the quantized image 130, thereby generating a decoded image 140. The super-resolution processor 112 receives the metadata 132 and the decoded image 140 and provides super-resolution of the decoded image 140 based on the metadata 132, thereby generating a super-resolved image 142 having a resolution similar to the captured image 122 or, for some embodiments, a resolution higher than that of the captured image 122.

In these embodiments, information useful for the SR process may be extracted from the original (uncompressed) image 124 and added as metadata 132 in the encoded image bitstream 130. Then this metadata 132 may be used by the super-resolution processor 112 to increase the spatial and/or temporal resolution(s). Since the metadata 132 are extracted from the original image 124, they are much more accurate for SR as compared to any information that may be extracted from a compressed image, such as the quantized image 130, or from a decompressed image, such as the decoded image 140. In addition, the SR parameters may be determined at the image-encoding system 100a and used by the super-resolution processor 112 at the image-decoding system 100b, resulting in a substantial reduction in decoding complexity.

In other embodiments, where the encoder 104 processes a downsampled image, the metadata 132 extracted from the pre-downsampled image is much more accurate than any information that may extracted from the downsampled image or from the compressed, downsampled image. In yet another system implementation, the camera 102 would be replaced by a server providing decoded bitstreams that had been compressed previously. Although these decoded bitstreams already have quantization artifacts, the embodiments with the downsampling after the metadata extractor 106 would still benefit a subsequent super-resolution processor 112 because the metadata 132 would be extracted from the pre-downsampled image and such metadata 132 would be superior to any other information as explained above. In this disclosure, the terms “lightly quantized” or “moderately quantized” may be substituted for “unquantized” throughout. Because metadata 132 is extracted from an unquantized, lightly quantized or moderately quantized input image, a subsequent encoding process may utilize heavy quantization to create a low-rate bitstream. The subsequent super-resolution processor 112 will use the metadata 132 to generate a high-quality, high-resolution image from the decoded, heavily quantized image. Without such metadata 132, the super-resolution processor 112 cannot recover a high-quality image from a heavily quantized image.

The metadata 132 extracted from the digital image 124 by the metadata extractor 106 may comprise any information suitable for the operation of SR, including pre-smoothing filters, motion information, downsampling ratios or filters, blurring filters, a database of spatio-temporal patches, patch numbers, dictionary coefficients, statistical parameters, patch-translation vectors, edge-characterization parameters, best-matching segments, information to reduce occlusion, multiple camera parameters, descriptors, internal parameters of the camera 102 and/or the like, as described in more detail below.

For example, using metadata 132 that includes motion information (for MFSR or MVSR), a motion field with higher resolution and/or greater accuracy may be generated. In conventional encoders, block-matching motion estimation is used to provide a rudimentary motion field that enables acceptable coding efficiency. However, when super-resolution is performed after decoding, this rudimentary motion field lacks the requisite resolution and accuracy. Furthermore, a sufficiently accurate, high-resolution motion field cannot be estimated at the decoder because the decoded content has been degraded by lossy compression artifacts. Thus, at the image-encoding system 100a, the metadata extractor 106 may be configured to estimate an accurate, high-resolution SR motion field and encode it efficiently as SR metadata 132 in the bitstream (i.e., 130+132). At the image-decoding system 100b, this accurate, high-resolution SR motion field 132 allows the super-resolution processor 112 to provide a high-quality, high-resolution output 142 that is not otherwise achievable from lossy-compressed data. In some embodiments, bi-directional, pixel-wise motion estimation (e.g., optical flow), which is more precise than block-matching motion estimation, may be used to generate the accurate, high-resolution motion field metadata 132.

As another alternative for using metadata 132 that includes motion information (for MFSR or MVSR), the metadata 132 may comprise a motion validity map. For these embodiments, the metadata 132 may be used to detect and mark pixels and/or blocks whose estimated motions for a current reference frame are inaccurate. This improves super-resolution performance by improving motion-information accuracy.

For some embodiments, the metadata 132 may include downsampling information. For example, the metadata 132 may comprise a spatial downsampling ratio. In this example, the super-resolution processor 112 may be configured to upsample the decoded image 140 to its original spatial size by using the spatial downsampling ratio. For another example, the metadata 132 may comprise a temporal downsampling ratio. In this example, the super-resolution processor 112 may be configured to up-convert the decoded image 140 to its original frame rate by using the temporal downsampling ratio. For yet another example, the metadata 132 may comprise a downsampling filter. In this example, the operations of super-resolution and image coding may be improved by using the downsampling filter.

For some embodiments, the metadata 132 may include a filter. For example, the metadata 132 may comprise a blurring filter. In this example, the digital image 124 can be blurred with a low-pass spatio-temporal filter before quantization (to reduce the bit rate). The super-resolution processor 112 may be configured to de-blur the decoded image 140 using a de-blurring super-resolution method based on the blurring filter. In another example, the digital image 124 may already have blurring that occurred earlier in the image acquisition pipeline. The metadata extractor 106 would then estimate the blurring filter from the un-quantized digital image 124 and transmit the estimated filter as metadata 132. The super-resolution processor 112 may be configured to de-blur the decoded image 140 using a de-blurring super-resolution method based on the blurring filter from the metadata 132.

For metadata 132 including a database of spatio-temporal patches (for SFSR), the super-resolution processor 112 may be configured to use the database in an SISR operation to replace low-resolution patches with corresponding high-resolution patches. For metadata 132 including patch numbers (for SFSR), the metadata extractor 106 may be configured to encode reference numbers corresponding to patches for which good matches exist in the database instead of encoding the patches themselves. For these embodiments, the super-resolution processor 112 may be configured to recover the identified patches from the database by using the reference numbers provided in the metadata 132. In this way, the compression ratio can be greatly improved.

For metadata 132 including information to reduce occlusion (for MFSR), the metadata 132 may comprise long-term reference frame numbers that may be used to improve the performance of motion compensation. For some embodiments, this metadata 132 may reference frames that contain an object that has been occluded in adjacent frames.

For metadata 132 including multiple camera parameters (for MVSR), the metadata 132 may comprise viewing-angle difference parameters for video sequences that are available from multiple views (i.e., multi-view scenarios). The super-resolution processor 112 may be configured to use this metadata 132 to combine the video sequences more accurately.

For metadata 132 including descriptors, the super-resolution processor 112 may be configured to reconstruct the output image 142 from descriptors comprising sufficient information. For example, for some embodiments, the metadata 132 may comprise scale-invariant feature transform descriptors with local information across various scales at keypoint locations. The super-resolution processor 112 may be configured to use this metadata 132 to improve the quality of the output image 142 at those keypoints.

For metadata 132 including internal parameters of the camera 102, the metadata 132 may comprise exposure time, aperture size, white balancing, ISO level and/or the like. The super-resolution processor 112 may be configured to provide more accurate blur estimation using this metadata 132, thereby improving super-resolution performance.

As described in more detail below, the metadata 132 can be carried using network abstraction layer unit (NALU), supplemental enhancement information (SEI), or any other parameter suitable for information encapsulation.

Although FIG. 1 illustrates one example of a system 100 for providing super-resolution, various changes may be made to FIG. 1. For example, the makeup and arrangement of the system 100 are for illustration only. Components could be added, omitted, combined, subdivided, or placed in any other suitable configuration according to particular needs. For example, the encoder 104 and/or the metadata extractor 106 may be included as components within the camera 102. Also, for example, a downsampler may be included in the image-encoding system 100a.

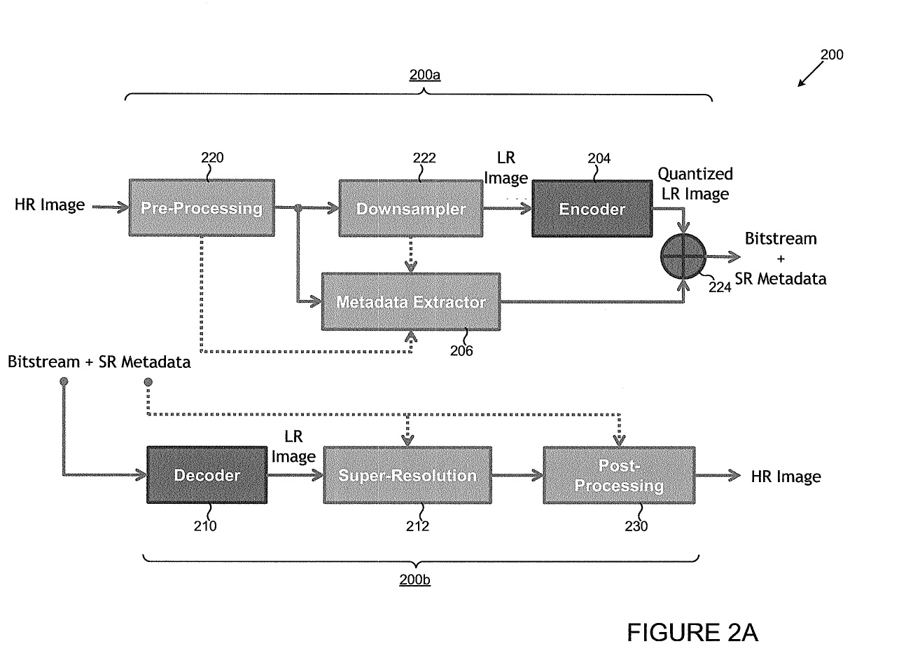

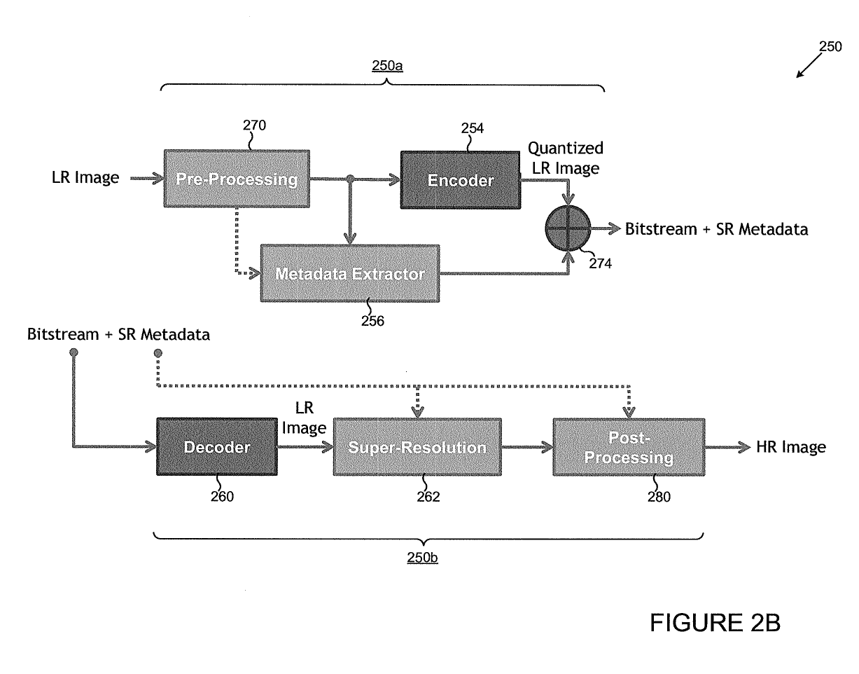

FIG. 2A illustrates a system 200 for processing a high-resolution video stream using the super-resolution process described with reference to FIG. 1 according to an embodiment of the disclosure. The system 200 shown in FIG. 2 is for illustration only. A system for processing a high-resolution video stream may be configured in any other suitable manner without departing from the scope of this disclosure.

As used herein, “high-resolution” and “low-resolution” are terms used relative to each other. Thus, a “high-resolution” video stream refers to any suitable video stream having a higher resolution than a video stream referred to as a “low-resolution” video stream. Thus, for a particular example, when a high-resolution video stream comprises an ultra-high-definition video stream, a low-resolution video may comprise a high-definition video stream.

The illustrated system 200 includes an image-encoding system 200a and an image-decoding system 200b. The image-encoding system 200a includes an encoder 204, a metadata extractor 206, a pre-processing block 220, a downsampler 222 and a combiner 224. The image-decoding system 200b includes a decoder 210, a super-resolution processor 212 and a post-processing block 230. For some embodiments, the encoder 204, metadata extractor 206, decoder 210 and super-resolution processor 212 may each correspond to the encoder 104, metadata extractor 106, decoder 110 and super-resolution processor 112 of FIG. 1, respectively.

For the illustrated embodiment, the pre-processing block 220 is configured to receive as an input a high-resolution image, to perform pre-processing on the image, and to provide the processed image to the downsampler 222 and the metadata extractor 206. The pre-processing block 220 is also configured to provide the unprocessed high-resolution image to the metadata extractor 206.

The downsampler 222 is configured to downsample the processed image to generate a low-resolution image and to provide the low-resolution image to the encoder 204. For some embodiments, the downsampler 222 may also be configured to provide downsampling information to the metadata extractor 206 corresponding to the processed image. For example, the downsampling information may comprise a spatial downsampling ratio, a temporal downsampling ratio, a downsampling filter and/or the like.

The encoder 204 is configured to encode the low-resolution image by quantizing the image to generate a quantized, low-resolution image. The metadata extractor 206 is configured to extract metadata from the high-resolution image for use in performing super-resolution. For some embodiments, the metadata extractor 206 may include downsampling information from the downsampler 222 in the metadata. The combiner 224 is configured to combine the quantized, low-resolution image and the super-resolution metadata to generate an output for the image-encoding system 200a. Thus, the output comprises a bitstream that includes the quantized, low-resolution image, along with the super-resolution metadata extracted by the metadata extractor 206.

The image-decoding system 200b is configured to receive the output from the image-encoding system 200a. The image-decoding system 200b may comprise a component configured to separate the bitstream from the super-resolution metadata (not shown in FIG. 2A). The decoder 210 is configured to decode the quantized, low-resolution image in the bitstream to generate a decoded image. The super-resolution processor 212 is configured to receive the decoded image and the SR metadata and to perform super-resolution on the decoded image based on the SR metadata to generate a super-resolved image.

For embodiments in which the downsampler 222 provides downsampling information to the metadata extractor 206 for inclusion with the metadata, the super-resolution processor 212 may be configured to upsample the decoded image to its original spatial size by using a spatial downsampling ratio, to up-convert the decoded image to its original frame rate by using a temporal downsampling ratio, to use a downsampling filter to improve the operations of super-resolution and image coding, or for any other suitable super-resolution process based on the downsampling information included in the SR metadata.

The post-processing block 230 is configured to perform post-processing on the super-resolved image to generate a high-resolution image as an output of the image-decoding system 200b. Thus, the resolution of the output of the image-decoding system 200b is substantially equivalent to the resolution of the image input to the image-encoding system 200a. In this way, the bitrate of the stream transmitted from the image-encoding system 200a to the image-decoding system 200b is significantly reduced without downgrading the image quality.

Although FIG. 2A illustrates one example of a system 200 for processing a high-resolution video stream, various changes may be made to FIG. 2A. For example, the makeup and arrangement of the system 200 are for illustration only. Components could be added, omitted, combined, subdivided, or placed in any other suitable configuration according to particular needs.

FIG. 2B illustrates a system 250 for generating a high-resolution video stream from a low-resolution video stream using the super-resolution process described with reference to FIG. 1 according to another embodiment of the disclosure. The system 250 shown in FIG. 2B is for illustration only. A system for generating a high-resolution video stream from a low-resolution video stream may be configured in any other suitable manner without departing from the scope of this disclosure.

The illustrated system 250 includes an image-encoding system 250a and an image-decoding system 250b. The image-encoding system 250a includes an encoder 254, a metadata extractor 256, a pre-processing block 270 and a combiner 274. The image-decoding system 250b includes a decoder 260, a super-resolution processor 262 and a post-processing block 280. For some embodiments, the encoder 254, metadata extractor 256, decoder 260 and super-resolution processor 262 may each correspond to the encoder 104, metadata extractor 106, decoder 110 and super-resolution processor 112 of FIG. 1, respectively.

For the illustrated embodiment, the pre-processing block 270 is configured to receive as an input a low-resolution image, to perform pre-processing on the image, and to provide the processed image to the encoder 254 and the metadata extractor 256. The pre-processing block 270 is also configured to provide the unprocessed low-resolution image to the metadata extractor 256.

The encoder 254 is configured to encode the low-resolution image by quantizing the image to generate a quantized, low-resolution image. The metadata extractor 256 is configured to extract metadata from the unprocessed low-resolution image for use in performing super-resolution. The combiner 274 is configured to combine the quantized, low-resolution image and the super-resolution metadata to generate an output for the image-encoding system 250a. Thus, the output comprises a bitstream that includes the quantized, low-resolution image, along with the super-resolution metadata extracted by the metadata extractor 256.

The image-decoding system 250b is configured to receive the output from the image-encoding system 250a. The image-decoding system 250b may comprise a component configured to separate the bitstream from the super-resolution metadata (not shown in FIG. 2B). The decoder 260 is configured to decode the quantized, low-resolution image in the bitstream to generate a decoded, low-resolution image. The super-resolution processor 262 is configured to receive the decoded, low-resolution image and the SR metadata and to perform super-resolution on the decoded, low-resolution image based on the SR metadata to generate a super-resolved image. The post-processing block 280 is configured to perform post-processing on the super-resolved image to generate a high-resolution image as an output of the image-decoding system 250b. Thus, the resolution of the output of the image-decoding system 250b is a higher resolution than that of the image input to the image-encoding system 250a. In this way, the resolution of the encoded video is significantly improved without increasing the bitrate of the stream transmitted from the image-encoding system 250a to the image-decoding system 250b.

Although FIG. 2B illustrates one example of a system 250 for generating a high-resolution video stream from a low-resolution video stream, various changes may be made to FIG. 2B. For example, the makeup and arrangement of the system 250 are for illustration only. Components could be added, omitted, combined, subdivided, or placed in any other suitable configuration according to particular needs.

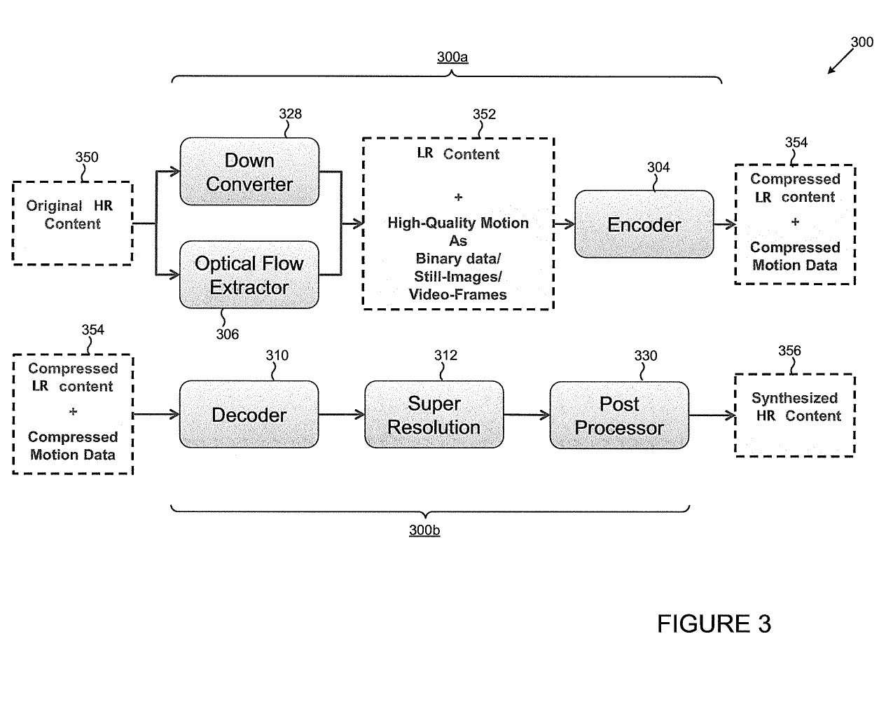

FIG. 3 illustrates a system 300 for providing super-resolution using optical flow metadata according to an embodiment of the disclosure. The system 300 shown in FIG. 3 is for illustration only. Super-resolution using optical flow metadata may be provided in any other suitable manner without departing from the scope of this disclosure.

The illustrated system 300 includes an image-encoding system 300a and an image-decoding system 300b. The image-encoding system 300a includes an encoder 304, an optical flow extractor 306 and a down converter 328. The image-decoding system 300b includes a decoder 310, a super-resolution processor 312 and a post-processing block 330. For some embodiments, the encoder 304, optical flow extractor 306, decoder 310 and super-resolution processor 312 may each correspond to the encoder 104, metadata extractor 106, decoder 110 and super-resolution processor 112 of FIG. 1, respectively. Also, for some embodiments, the down converter 328 may correspond to the downsampler 222 of FIG. 2A.

For the illustrated embodiment, the down converter 328 and the optical flow extractor 306 are configured to receive original high-resolution content 350. The down converter 328 is configured to down convert the high-resolution content 350 to generate low-resolution content. The optical flow extractor 306 is configured to extract optical flow metadata from the high-resolution content 350 for use in performing super-resolution. Thus, together the down converter 328 and the optical flow extractor 306 generate low-resolution content and high-quality motion metadata 352 for the encoder 304. The encoder 304 is configured to encode the low-resolution content and high-quality motion metadata 352 to generate a compressed, low-resolution content and compressed motion metadata 354.

The image-decoding system 300b is configured to receive the compressed, low-resolution content and compressed motion metadata 354 from the image-encoding system 300a. The decoder 310 is configured to decode the compressed, low-resolution content to generate a decoded image and to decode the compressed motion metadata to generate decoded metadata. The super-resolution processor 312 is configured to perform super-resolution on the decoded image based on the decoded metadata to generate a super-resolved image. The post-processing block 330 is configured to perform post-processing on the super-resolved image to generate synthesized, high-resolution content 356 as an output of the image-decoding system 300b. Thus, the resolution of the output content 356 of the image-decoding system 300b is substantially equivalent to the resolution of the content 350 input to the image-encoding system 300a.

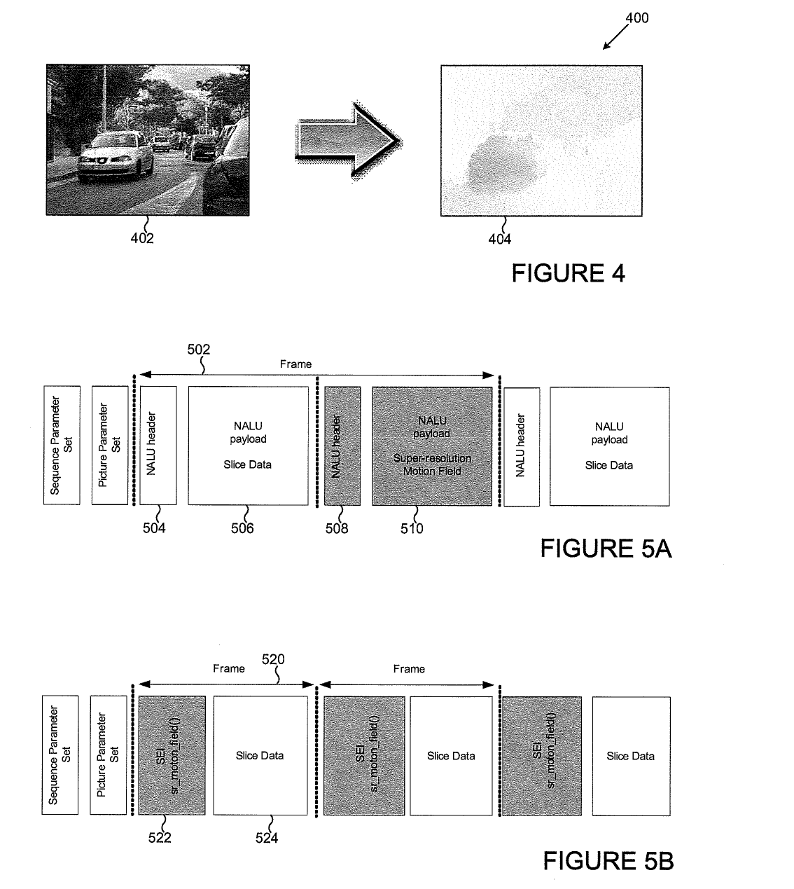

FIG. 4 illustrates a process 400 of generating the optical flow metadata of FIG. 3 using the optical flow extractor 306 according to an embodiment of the disclosure. This process 400 provides an optical flow approach to performing MFSR, which uses accurate motion estimation to align low-resolution video frames.

For this embodiment, which may be implemented in the system 300, the optical flow extractor 306 is configured to estimate optical flow from the original high-resolution content 350 before the encoder 304 encodes the data 352. The estimated optical flow may be used as metadata to efficiently up-convert the compressed low-resolution content 354 back to high-resolution content 356 after decoding.

The illustrated process 400 shows a still frame 402 from a video sequence in which a subsequent frame (not shown in FIG. 4) shows slight movement of the background image, with substantially more movement of the vehicle to the left in the frame 402. Therefore, for this movement, the optical flow extractor 306 may be configured to generate an estimated flow field 404 as illustrated. For some embodiments, the flow field 404 may be visualized with a color pattern. Thus, although shown as black-and-white with darker shades indicating more movement, it will be understood that the flow field 404 may comprise color content to indicate movement with, for example, colors nearer to violet on a color scale indicating more movement and colors nearer to red indicating less movement or vice versa.

The optical flow extractor 306 may be configured to generate optical flow metadata in any suitable format. For example, the optical flow metadata may comprise binary data, individual still images (to leverage spatial redundancy), video sequences synchronized to the high-resolution content 350 (to leverage spatial/temporal redundancy), or the like. For some embodiments, as shown in FIG. 3, optical flow metadata can be downsampled to achieve higher compression.

For alternative embodiments of an optical flow approach to performing MFSR, the optical flow extractor 306 may be configured to generate subsampled optical flow metadata. For these embodiments, the optical flow extractor 306 may be configured to extract motion information over selected pixels or regions instead of using a dense, pixel-wise optical flow as described above with reference to FIG. 4.

For a particular example, the optical flow extractor 306 may be configured to identify salient pixels or regions in adjacent input frames. The super-resolution processor 312 may be configured to find the corresponding locations in the input images, so the image-encoding system 300a does not have to provide the location information to the image-decoding system 300b. For this example, the image-encoding system 300a may be configured to transmit sparse optical flow information in high-resolution frames as the SR metadata.

The relationship between high-resolution and low-resolution frames may be provided in these embodiments as follows:

yₖ=Wₖxₖ+eₖ

where yₖ is the k^{th} low-resolution frame, xₖ is the k^{th} high-resolution frame, Wₖ is the observation matrix for xₖ, and eₖ denotes noise in the k^{th} measurement.

Also, for these embodiments, motion constraints may be implemented only on features based on the following:

xₖ₊₁=Fₖxₖ+fₖ

where xₖ₊₁ is the (k+1)^{th} high-resolution frame, Fₖ is the k^{th} forward motion operator, xₖ is the k^{th} high-resolution frame, and fₖ is the k^{th} forward motion-compensated residual.

To implement this subsampled optical flow approach, for some embodiments, the optical flow extractor 306 may be initialized with affine constraints on the motion at selected locations. Then the optical flow extractor 306 may iteratively refine the motion estimate over the entire view. Alternatively, for other embodiments, the optical flow extractor 306 may randomly subsample a dense optical flow.

In these ways, subsampled optical flow may be implemented by the optical flow extractor 306 to generate SR metadata for select pixels or regions. These pixels or regions may be selected based on perceptually important features (e.g., using feature detection), based on salient sub-pixel motion, by random sub-sampling, by using a saliency map over high/low-resolution images and/or in any other suitable manner. Note that the random subsampling allows the locations of the pixels or regions to be transmitted very efficiently as metadata: all locations are completely described by the pseudorandom, generator seed (an integer), and the number of random locations. At the receiver, the pseudorandom generator is initialized with the transmitted seed and the specified number of random locations will be synthesized by the generator. Since both the transmitter and the receiver use the same generator with the same seed, the locations that are synthesized at the receiver will be identical to those synthesized at the transmitter.

As described above, for some embodiments, SR metadata can be carried using NALU. For the following description, motion field metadata (such as optical flow metadata) encapsulation using NALU is used as a particular example with reference to FIG. 3. However, it will be understood that metadata encapsulation using NALU may be similarly implemented in any suitable image-processing system. For this example, NALU as defined in H.264/AVC is used. An HEVC-associated NALU extension can be implemented similarly.

Typically, a NALU includes two parts: a NALU header and its payload. The NALU header is parsed at the image-decoding system 300b for appropriate decoding operations. For example, if the NALU header indicates a current NALU is a sequence parameter set (SPS), then SPS parsing and initialization will be activated; alternatively, if the NALU header indicates a current NALU is a slice NALU, then the slice decoding is launched.

In H.264/AVC and its extensions, NALU is byte-aligned. The NALU header is either a 1-byte field or a 4-byte field, depending on whether the NALU is a regular single-layer packet or a scalable packet. Table 1 below shows the NALU syntax and its parsing process for H.264/AVC and its extensions.

TABLE 1
NALU syntax in H.264/AVC and its extensions

| nal_unit( NumBytesInNALunit ) { | | C | Descriptor |
|---|---|---|---|
| | forbidden_zero_bit | All | f(1) |
| | nal_ref_idc | All | u(2) |
| | nal_unit_type | All | u(5) |
| | NumBytesInRBSP = 0 | | |
| | nalUnitHeaderBytes = 1 | | |
| | if( nal_unit_type == 14 \|\| nal_unit_type == 20 ) { | | |

| | | |
|---|---|---|
| svc_extension_flag | All | u(1) |
| if( svc_extension_flag ) | | |

| | |
|---|---|
| nal_unit_header_svc_extension( ) /* specified in Annex G */ | All |

else

| | |
|---|---|
| nal_unit_header_mvc_extension( ) /* specified in Annex H */ | All |

nalUnitHeaderBytes += 3

}
for( i = nalUnitHeaderBytes; i < NumBytesInNALunit; i++ ) {

if( i + 2 < NumBytesInNALunit && next_bits( 24 ) == 0x000003 ) {

| | | |
|---|---|---|
| rbsp_byte[ NumBytesInRBSP++ ] | All | b(8) |
| rbsp_byte[ NumBytesInRBSP++ ] | All | b(8) |
| i += 2 | | |
| emulation_prevention_three_byte /* equal to 0x03 */ | All | f(8) |

} else

| | | |
|---|---|---|
| rbsp_byte[ NumBytesInRBSP++ ] | All | b(8) |

}

}

A standard 1-byte NALU header includes the 1-bit forbidden_zero_bit (zero), a 3-bit nal_ref_idc indicating whether the NALU can be referred, and a 5-bit nal_unit_type showing the type of following NALU payload. If nal_unit_type equals 14 or 20, an extra three bytes are parsed to derive the information for H.264 scalable video.

FIG. 5A illustrates frame-based insertion of an extended NALU header for use in the process 300 of FIG. 3 according to an embodiment of the disclosure. The example shown in FIG. 5A is for illustration only. An extended NALU header may be implemented in any other suitable manner without departing from the scope of this disclosure. In addition, frame-based insertion of an extended NALU header may also be implemented in any suitable super-resolution system other than the system 300 of FIG. 3 without departing from the scope of this disclosure.

For the illustrated embodiment, a frame 502 comprises an extended NALU header 504, followed by a NALU payload including slice data 506, a second extended NALU header 508, and a NALU payload including SR motion field metadata 510.

As shown in Table 2, below, H.264/AVC defines the content of each nal_unit_type for appropriate parsing and decoding, where values from 24 to 31 are unspecified. Therefore, for the system 300, a nal_unit_type is implemented for an SR motion field. For these embodiments, nal_unit_type=n may indicate information associated with the SR motion field, where n is a particular one of the unspecified values, i.e., 24-31. When nal_unit_type=n, sr_motion_field( ) is used to parse and initialize the decoding super-resolution motion field related data. When the image-decoding system 300b parses this NALU header, the frame-level motion field reconstruction and super-resolution are enabled. Tables 3 and 4 below show a modification to extend the current definition of NALU header to support this motion-field information encapsulation.

TABLE 2
nal_unit_type definitions in H.264/AVC

| | | | | Annex G |
|---|---|---|---|---|
| | | | Annex A | and Annex H |
| | | | NAL unit | NAL unit |
| nal_unit_type | Content of NAL unit and RBSP syntax structure | C | type class | type class |
| 0 | Unspecified | | non-VCL | non-VCL |
| 1 | Coded slice of a non-IDR picture | 2, 3, 4 | VCL | VCL |
| | slice_layer_without_partitioning_rbsp( ) | | | |
| 2 | Coded slice data partition A | 2 | VCL | not |
| | slice_data_partition_a_layer_rbsp( ) | | | applicable |
| 3 | Coded slice data partition B | 3 | VCL | not |
| | slice_data_partition_b_layer_rbsp( ) | | | applicable |
| 4 | Coded slice data partition C | 4 | VCL | not |
| | slice_data_partition_c_layer_rbsp( ) | | | applicable |
| 5 | Coded slice of an IDR picture | 2, 3 | VCL | VCL |
| | slice_layer_without_partitioning_rbsp( ) | | | |
| 6 | Supplemental enhancement information (SEI) | 5 | non-VCL | non-VCL |
| | sei_rbsp( ) | | | |
| 7 | Sequence parameter set | 0 | non-VCL | non-VCL |
| | seq_parameter_set_rbsp( ) | | | |
| 8 | Picture parameter set | 1 | non-VCL | non-VCL |
| | pic_parameter_set_rbsp( ) | | | |
| 9 | Access unit delimiter | 6 | non-VCL | non-VCL |
| | access_unit_delimiter_rbsp( ) | | | |
| 10 | End of sequence | 7 | non-VCL | non-VCL |
| | end_of_seq_rbsp( ) | | | |
| 11 | End of stream | 8 | non-VCL | non-VCL |
| | end_of_stream_rbsp( ) | | | |
| 12 | Filler data | 9 | non-VCL | non-VCL |
| | filler_data_rbsp( ) | | | |
| 13 | Sequence parameter set extension | 10 | non-VCL | non-VCL |
| | seq_parameter_set_extension_rbsp( ) | | | |
| 14 | Prefix NAL unit | 2 | non-VCL | suffix |
| | prefix_nal_unit_rbsp( ) | | | dependent |
| 15 | Subset sequence parameter set | 0 | non-VCL | non-VCL |
| | subset_seq_parameter_set_rbsp( ) | | | |
| 16 . . . 18 | Reserved | | non-VCL | non-VCL |
| 19 | Coded slice of an auxiliary coded picture without partitioning | 2, 3, 4 | non-VCL | non-VCL |
| | slice_layer_without_partitioning_rbsp( ) | | | |
| 20 | Coded slice extension | 2, 3, 4 | non-VCL | VCL |
| | slice_layer_extension_rbsp( ) | | | |
| 21 . . . 23 | Reserved | | non-VCL | non-VCL |
| 24 . . . 31 | Unspecified | | non-VCL | non-VCL |

TABLE 3
Extended NAL unit syntax

| nal_unit( NumBytesInNALunit ) { | | C | Descriptor |
|---|---|---|---|
| | forbidden_zero_bit | All | f(1) |
| | nal_ref_idc | All | u(2) |
| | nal_unit_type | All | u(5) |
| | NumBytesInRBSP = 0 | | |
| | nalUnitHeaderBytes = 1 | | |
| | if( nal_unit_type = = 14 \| \| nal_unit_type = = | | |

| | | |
|---|---|---|
| svc_extension_flag | All | u(1) |
| if( svc_extension_flag ) | | |

| | |
|---|---|
| nal_unit_header_svc_extension( ) /* specified in | All |

Else

| | |
|---|---|
| nal_unit_header_mvc_extension( ) /* specified in | All |

nalUnitHeaderBytes += 3

}
if (nal_unit_tyoe == 24 /* or any unspecified

| | | |
|---|---|---|
| sr_motion_field_flag | All | u(1) |
| if (sr_motion_field_flag ) | | |

sr_motion_field( ) /*specified in Annex ?*/

| | | |
|---|---|---|
| } | | |
| for( i = nalUnitHeaderBytes; i < | | |
| if( i + 2 < NumBytesInNALunit && next_bits( 24 ) | | |
| rbsp_byte[ NumBytesInRBSP++ ] | All | b(8) |

| | | |
|---|---|---|
| rbsp_byte[ NumBytesInRBSP++ ] | All | b(8) |
| i += 2 | | |

| | | |
|---|---|---|
| emulation_prevention_three_byte /* equal to 0x03 */ | All | f(8) |

| | | |
|---|---|---|
| } else | | |
| rbsp_byte[ NumBytesInRBSP++ ] | All | b(8) |
| } | | |
| } | | |

TABLE 4
Extended NAL unit type definition

| | | | | Annex G |
|---|---|---|---|---|
| | | | Annex A | and Annex H |
| | | | NAL unit | NAL unit |
| nal_unit_type | Content of NAL unit and RBSP syntax structure | C | type class | type |
| 0 | Unspecified | | non-VCL | non-VCL |
| 1 | Coded slice of a non-IDR picture | 2, 3, 4 | VCL | VCL |
| | slice_layer_without_partitioning_rbsp( ) | | | |
| 2 | Coded slice data partition A | 2 | VCL | N/A |
| | slice_data_partition_a_layer_rbsp( ) | | | |
| 3 | Coded slice data partition B | 3 | VCL | N/A |
| | slice_data_partition_b_layer_rbsp( ) | | | |
| 4 | Coded slice data partition C | 4 | VCL | N/A |
| | slice_data_partition_c_layer_rbsp( ) | | | |
| 5 | Coded slice of an IDR | 2, 3 | VCL | VCL |
| | picture slice_layer_without_partitioning_rbsp( ) | | | |
| 6 | Supplemental enhancement information (SEI) | 5 | non-VCL | non-VCL |
| | sei_rbsp( ) | | | |
| 7 | Sequence parameter set | 0 | non-VCL | non-VCL |
| | seq_parameter_set_rbsp( ) | | | |
| 8 | Picture parameter set | 1 | non-VCL | non-VCL |
| | pic_parameter_set_rbsp( ) | | | |
| 9 | Access unit delimiter | 6 | non-VCL | non-VCL |
| | access_unit_delimiter_rbsp( ) | | | |
| 10 | End of sequence | 7 | non-VCL | non-VCL |
| | end_of_seq_rbsp( ) | | | |
| 11 | End of stream | 8 | non-VCL | non-VCL |
| | end_of_stream_rbsp( ) | | | |
| 12 | Filler data | 9 | non-VCL | non-VCL |
| | filler_data_rbsp( ) | | | |
| 13 | Sequence parameter set extension | 10 | non-VCL | non-VCL |
| | seq_parameter_set_extension_rbsp( ) | | | |
| 14 | Prefix NAL unit | 2 | non-VCL | suffix |
| | prefix_nal_unit_rbsp( ) | | | depended |
| 15 | Subset sequence parameter set | 0 | non-VCL | non-VCL |
| | subset_seq_parameter_set_rbsp( ) | | | |
| 16 . . . 18 | Reserved | | non-VCL | non-VCL |
| 19 | Coded slice of an auxiliary coded picture without partitioning | 2, 3, 4 | non-VCL | non-VCL |
| | slice_layer_without_partitioning_rbsp( ) | | | |
| 20 | Coded slice extension | 2, 3, 4 | non-VCL | VCL |
| | slice_layer_extension_rbsp( ) | | | |
| 21 . . . 23 | Reserved | | non-VCL | non-VCL |
| 24 | Super-resolution motion field | | VCL | VCL |
| | sr_motion_field( ) | | | |
| 25 . . . 31 | Unspecified | | non-VCL | non-VCL |

FIG. 5B illustrates frame-level SR motion field encapsulation for use in the process of FIG. 3 according to an embodiment of the disclosure. The example shown in FIG. 5B is for illustration only. Frame-level SR motion field encapsulation may be implemented in any other suitable manner without departing from the scope of this disclosure. In addition, frame-level SR motion field encapsulation may also be implemented in any suitable super-resolution system other than the system 300 of FIG. 3 without departing from the scope of this disclosure.

As described above, for some embodiments, SR metadata can be carried using SEI. For the following description, motion field metadata (such as optical flow metadata) encapsulation using SEI is used as a particular example with reference to FIG. 3. However, it will be understood that metadata encapsulation using SEI may be similarly implemented in any suitable image-processing system.

For the illustrated embodiment, a frame 520 comprises SEI 522, which includes SR motion field metadata, and slice data 524. Thus, for this example, the motion field information is embedded using SEI syntax. The encoder 304 may be configured to derive the SEI messages. A super-resolution motion field message (i.e., sr_motion_field( ) is defined to be inserted into the stream frame-by-frame by the encoder 304. That syntax can be parsed at the decoder 310 to improve the super-resolution performance.

For a particular example of this embodiment, the SEI message may be defined with payloadType=46 (as shown in Table 5). However, it will be understood that any available number may be used to define this SEI message. The decoder 310 may be configured to parse this SEI message and enable the frame-level motion field parsing as defined in Table 5. After the information is obtained, the super-resolution processor 312 can perform the super-resolution.

TABLE 5
SEI message defined in H.264/AVC

| | | |
|---|---|---|
| sei_payload( payloadType, payloadSize ) { | C | Descriptor |

if( payloadType = = 0 )

| | |
|---|---|
| buffering_period( payloadSize ) | 5 |

else if( payloadType = = 1 )

| | |
|---|---|
| pic_timing( payloadSize ) | 5 |

else if( payloadType = = 2 )

| | |
|---|---|
| pan_scan_rect( payloadSize ) | 5 |

else if( payloadType = = 3 )

| | |
|---|---|
| filler_payload( payloadSize ) | 5 |

else if( payloadType = = 4 )

| | |
|---|---|
| user_data_registered_itu_t_t35( payloadSize ) | 5 |

else if( payloadType = = 5 )

| | |
|---|---|
| user_data_unregistered( payloadSize ) | 5 |

else if( payloadType = = 6 )

| | |
|---|---|
| recovery_point( payloadSize ) | 5 |

else if( payloadType = = 7 )

| | |
|---|---|
| dec_ref_pic_marking_repetition( payloadSize ) | 5 |

else if( payloadType = = 8 )

| | |
|---|---|
| spare_pic( payloadSize ) | 5 |

else if( payloadType = = 9 )

| | |
|---|---|
| scene_info( payloadSize ) | 5 |

else if( payloadType = = 10 )

| | |
|---|---|
| sub_seq_info( payloadSize ) | 5 |

else if( payloadType = = 11 )

| | |
|---|---|
| sub_seq_layer_characteristics( payloadSize ) | 5 |

else if( payloadType = = 12 )

| | |
|---|---|
| sub_seq_characteristics( payloadSize ) | 5 |

else if( payloadType = = 13 )

| | |
|---|---|
| full_frame_freeze( payloadSize ) | 5 |

else if( payloadType = = 14 )

| | |
|---|---|
| full_frame_freeze_release( payloadSize ) | 5 |

else if( payloadType = = 15 )

| | |
|---|---|
| full_frame_snapshot( payloadSize ) | 5 |

else if( payloadType = = 16 )

| | |
|---|---|
| progressive_refinement_segment_start( payloadSize ) | 5 |

else if( payloadType = = 17 )

| | |
|---|---|
| progressive_refinement_segment_end( payloadSize ) | 5 |

else if( payloadType = = 18 )

| | |
|---|---|
| motion_constrained_slice_group_set( payloadSize ) | 5 |

else if( payloadType = = 19 )

| | |
|---|---|
| film_grain_characteristics( payloadSize ) | 5 |

else if( payloadType = = 20 )

| | |
|---|---|
| deblocking_filter_display_preference( payloadSize ) | 5 |

else if( payloadType = = 21 )

| | |
|---|---|
| stereo_video_info( payloadSize ) | 5 |

else if( payloadType = = 22 )

| | |
|---|---|
| post_filter_hint( payloadSize ) | 5 |

else if( payloadType = = 23 )

| | |
|---|---|
| tone_mapping_info( payloadSize ) | 5 |

else if( payloadType = = 24 )

| | |
|---|---|
| scalability_info( payloadSize ) /* specified in | 5 |

else if( payloadType = = 25 )

| | |
|---|---|
| sub_pic_scalable_layer( payloadSize ) /* specified | 5 |

else if( payloadType = = 26 )

| | |
|---|---|
| non_required_layer_rep( payloadSize ) /* specified | 5 |

else if( payloadType = = 27 )

| | |
|---|---|
| priority_layer_info( payloadSize ) /* specified in | 5 |

else if( payloadType = = 28 )

| | |
|---|---|
| layers_not_present( payloadSize ) /* specified in | 5 |

else if( payloadType = = 29 )

| | |
|---|---|
| layer_dependency_change( payloadSize ) /* | 5 |

else if( payloadType = = 30 )

| | |
|---|---|
| scalable_nesting( payloadSize ) /* specified in | 5 |

else if( payloadType = = 31 )

| | |
|---|---|
| base_layer_temporal_hrd( payloadSize ) /* | 5 |

else if( payloadType = = 32 )

| | |
|---|---|
| quality_layer_integrity_check( payloadSize ) /* | 5 |

else if( payloadType = = 33 )

| | |
|---|---|
| redundant_pic_property( payloadSize ) /* specified | 5 |

else if( payloadType = = 34 )

| | |
|---|---|
| tl0_dep_rep_index( payloadSize ) /* specified in | 5 |

else if( payloadType = = 35 )

| | |
|---|---|
| tl_switching_point( payloadSize ) /* specified in | 5 |

else if( payloadType = = 36 )

| | |
|---|---|
| parallel_decoding_info( payloadSize ) /* specified | 5 |

else if( payloadType = = 37 )

| | |
|---|---|
| mvc_scalable_nesting( payloadSize ) /* specified | 5 |
| in Annex H */ | |

else if( payloadType = = 38 )

| | |
|---|---|
| view_scalability_info( payloadSize ) /* specified | 5 |

else if( payloadType = = 39 )

| | |
|---|---|
| multiview_scene_info( payloadSize ) /* specified | 5 |

else if( payloadType = = 40 )

| | |
|---|---|
| multiview_acquisition_info( payloadSize ) /* | 5 |

else if( payloadType = = 41 )

| | |
|---|---|
| non_required_view_component( payloadSize ) /* | 5 |

else if( payloadType = = 42 )

| | |
|---|---|
| view_dependency_change( payloadSize ) /* specified | 5 |

else if( payloadType = = 43 )

| | |
|---|---|
| operation_points not_present( payloadSize ) /* | 5 |

else if( payloadType = = 44 )

| | |
|---|---|
| base_view_temporal_hrd( payloadSize ) /* specified | 5 |

else if( payloadType = = 45 )

| | |
|---|---|
| frame_packing_arrangement( payloadSize ) | 5 |

else if( payloadType = = 46 )

| | |
|---|---|
| sr_motion_field( payloadSize) /* specified for | 5 |

Else

| | |
|---|---|
| reserved_sei_message( payloadSize ) | 5 |

if( !byte_aligned( ) ) {

| | | |
|---|---|---|
| bit_equal_to_one /* equal to 1 */ | 5 | f(1) |
| while( !byte_aligned( ) ) | | |

| | | |
|---|---|---|
| bit_equal_to_zero /* equal to 0 */ | 5 | f(1) |

}

}

Although the preceding paragraphs have used the SR motion field as an example of metadata that can be transmitted using extended NAL units or SEI messages, it will be understood that any type of metadata could similarly be transmitted without departing from the scope of this disclosure. Similarly, other mechanisms such as MPEG Media Transport (MMT) or the like could be used instead of extended NAL units or SEI messages without departing from the scope of this disclosure.

Metadata compression can be realized using most straightforward fixed length codes or universal variable length codes. To achieve more compression gain, context adaptive variable length codes (such as Huffman codes) or content adaptive binary arithmetic codes may be applied to these metadata. In addition, standard prediction techniques can be used to eliminate redundancy in the metadata, thereby increasing coding efficiency. For example, the SR motion-field elements are highly correlated and can be de-correlated by predicting each element from its causal neighbors. In another embodiment, the high-resolution SR motion field may be coded as an enhancement to the lower-resolution motion field used for motion compensation in the bitstream.

Although FIG. 3 illustrates one example of a system 300 for providing super-resolution, various changes may be made to FIG. 3. For example, the makeup and arrangement of the system 300 are for illustration only. Components could be added, omitted, combined, subdivided, or placed in any other suitable configuration according to particular needs.

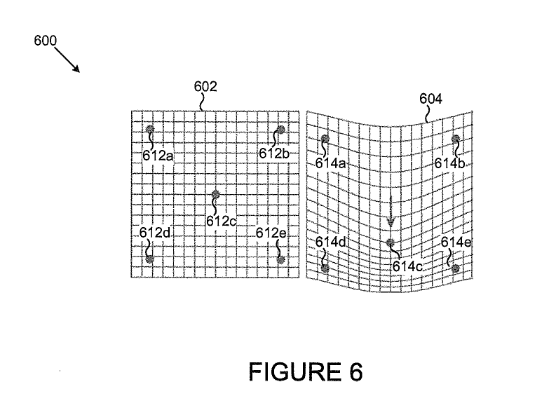

FIG. 6 illustrates a graphical representation 600 of scattered data interpolation for use in providing super-resolution according to an embodiment of the disclosure. The scattered data interpolation shown in FIG. 6 is for illustration only.

As described above, for some MFSR embodiments, SR metadata may comprise scattered data interpolation. For these embodiments, the image-encoding system is configured to transmit a subset of salient points from a more dense motion field as metadata. The metadata extractor is configured to select the points to be transmitted by identifying the points that cause the most influence (e.g., peaks or singularities). The image-decoding system is configured to use scattered data interpolation to estimate the dense motion field from the points transmitted by the image-encoding system.

For the illustrated example, the metadata extractor identifies five points 612a-e in the first frame 602 and their five corresponding points 614a-e in the second frame 604. The super-resolution processor may use these points 612a-e and 614a-e to fully determine the motion field that characterizes the motion between the two frames.

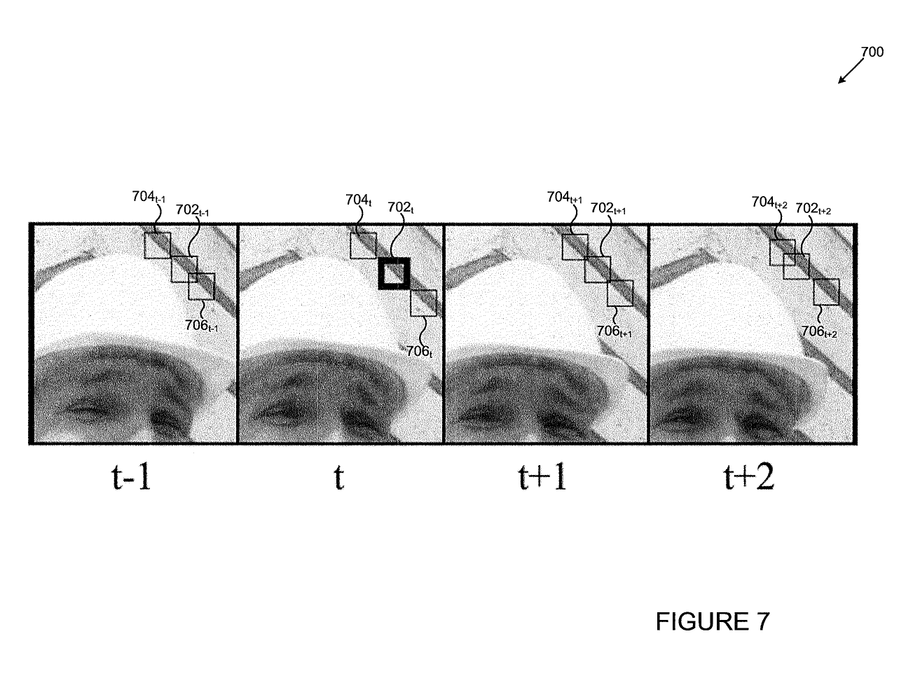

FIG. 7 illustrates a process 700 for providing super-resolution without using explicit motion estimation according to an embodiment of the disclosure. The process 700 shown in FIG. 7 is for illustration only. A process for providing super-resolution may be implemented in any other suitable manner without departing from the scope of this disclosure.

As described above, for some MFSR embodiments, SR metadata may be provided without explicit motion estimation. MFSR techniques generally rely on the availability of accurate motion estimation for the fusion task. When the motion is estimated inaccurately, as often happens for occluded regions and fast moving or deformed objects, artifacts may appear in the super-resolved outcome. However, recent developments in improving video de-noising include algorithms without explicit motion estimation, such as bilateral filtering and non-local mean (NLM). Thus, the illustrated process 700 may provide a super-resolution technique of a similar nature that allows sequences to be processed with general motion patterns.

Motion estimation with optical flow is a one-to-one correspondence between pixels in the reference frame and those within neighboring frames, and as such, it introduces sensitivity to errors. In contrast, this process 700 replaces this motion field with a probabilistic one that assigns each pixel in the reference image with many possible correspondences in each frame in the sequence (including itself), each with an assigned probability of being correct.

As shown in FIG. 7, at time t, a patch 702 is identified in a reference frame. The patch 702 in the reference frame has several probable locations (marked as patches 704ₜ and 706ₜ) in the reference frame. The patch 702ₜ also has several probable locations (patches 702ₜ₋₁, 704ₜ₋₁ and 706ₜ₋₁) in the frame corresponding to time t−1, several probable locations (patches 702ₜ₊₁, 704ₜ₊₁ and 706ₜ₊₁) in the frame corresponding to time t+1, and several probable locations (patches 702ₜ₊₂, 704ₜ₊₂ and 706ₜ₊₂) in the frame corresponding to time t+2.

Thus, for some embodiments, the metadata extractor may be configured to extract SR metadata comprising correspondence weights between each patch in the reference frame and similar patches within other frames.

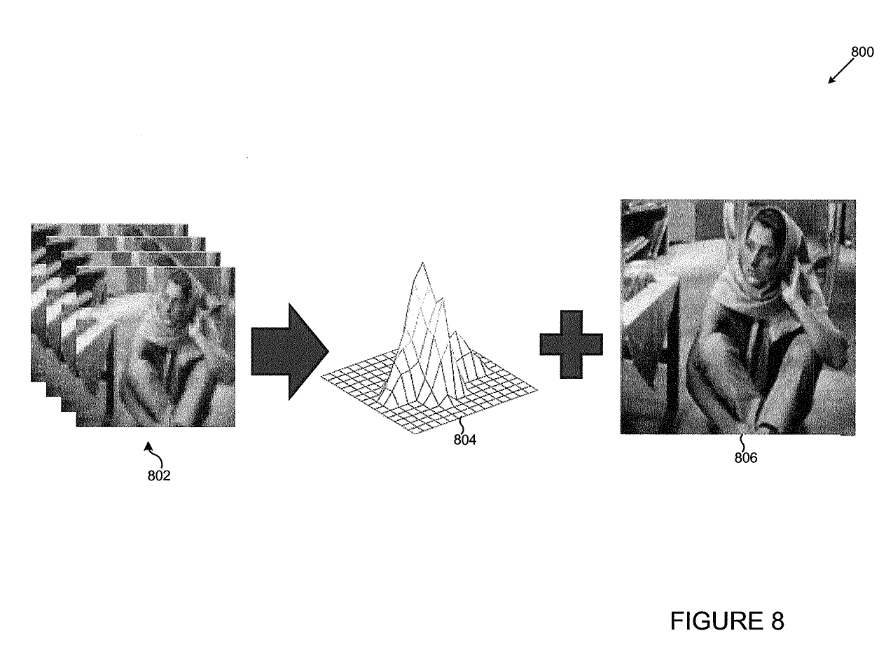

FIG. 8 illustrates a process 800 for providing blind super-resolution according to an embodiment of the disclosure. The process 800 shown in FIG. 8 is for illustration only. A process for providing super-resolution may be implemented in any other suitable manner without departing from the scope of this disclosure.

As described above, for some MFSR embodiments, blind super-resolution may be implemented. Most super-resolution techniques do not explicitly consider blur identification during the reconstruction procedure. Instead, they assume the blur (PSF) in the low-resolution images either is fully known a priori or is negligible and can be omitted from the super-resolution process. Alternatively, blind super-resolution techniques try to estimate the blur function along with the output high-resolution image in the super-resolution reconstruction process (a highly ill-posed optimization problem).

Therefore, for some embodiments, the SR metadata may comprise downsampling filter coefficients derived from the original high-resolution images by the metadata extractor. Based on the downsampling filter coefficients, the super-resolution processor may be configured to estimate a blur function 804 for one of a set of low-resolution input images 802 in order to generate a high-resolution output image 806. In this way, the super-resolution process 800 is substantially improved as compared to conventional blind super-resolution techniques.

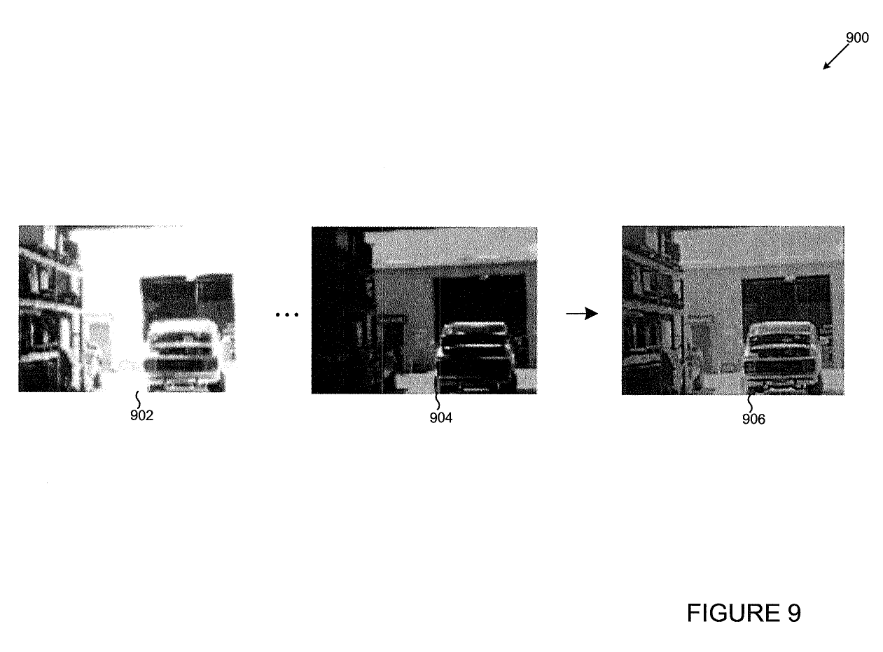

FIG. 9 illustrates a process 900 for providing super-resolution under photometric diversity according to an embodiment of the disclosure. The process 900 shown in FIG. 9 is for illustration only. A process for providing super-resolution may be implemented in any other suitable manner without departing from the scope of this disclosure.

As described above, for some MFSR embodiments, super-resolution under photometric diversity may be implemented. Most conventional super-resolution methods account for geometric registration only, assuming that images are captured under the same photometric conditions. However, optical flow easily fails under severe illumination variations. External illumination conditions and/or camera parameters (such as exposure time, aperture size, white balancing, ISO level or the like) may vary for different images and video frames.

Taking the camera response function (CRF) and the photometric camera settings into account improves the accuracy of photometric modeling. CRF, which is the mapping between the irradiance at a pixel to the output intensity, may not be linear due to saturation and manufacturer's preferences to improve contrast and visual quality. In the context of super-resolution, photometric variation may be modeled either as an affine or as a nonlinear transformation. Super-resolution can improve spatial/temporal resolution(s) and dynamic range.

Input frames may have photometric diversity. For example, as shown in FIG. 9, input frame 902 is highly illuminated, while input frame 904 is dimly illuminated. For some embodiments, the SR metadata may comprise a photometric map between images and video frames. The SR metadata may also comprise camera internal parameters (such as exposure time, aperture size, white balancing, ISO level or the like) if a parametric model is used. The super-resolution processor may be configured to apply the photometric map to compensate for lighting changes before optical-flow estimation to generate a super-resolved frame 906. In this way, a super-resolution process may be implemented that provides for accurate registration of the images, both geometrically and photometrically.

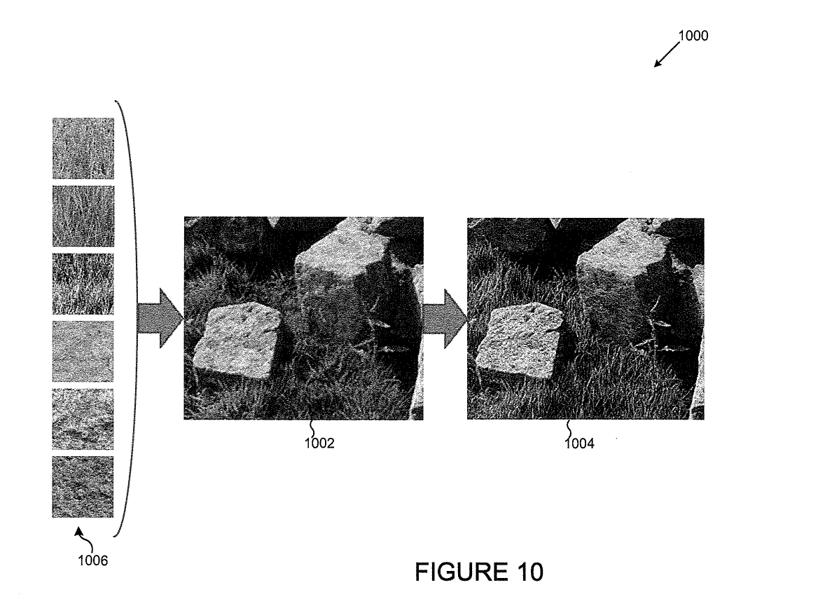

FIG. 10 illustrates a process 1000 for providing example-based super-resolution according to an embodiment of the disclosure. The process 1000 shown in FIG. 10 is for illustration only. A process for providing super-resolution may be implemented in any other suitable manner without departing from the scope of this disclosure.

As described above, for some SFSR embodiments, example-based super-resolution may be implemented. For these embodiments, an input frame 1002 may be super-resolved into a higher-resolution output frame 1004 based on a set of images 1006 that can be used to train a database for the super-resolution process.

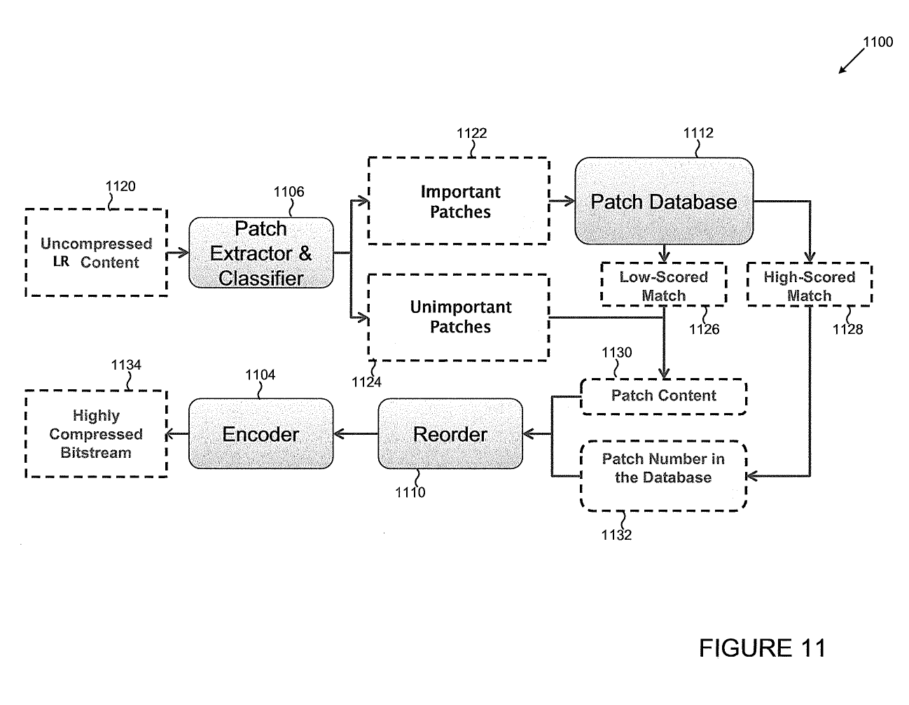

FIG. 11 illustrates a system 1100 for providing super-resolution using patch indexing according to an embodiment of the disclosure. The system 1100 shown in FIG. 11 is for illustration only. A system for providing super-resolution may be configured in any other suitable manner without departing from the scope of this disclosure.

As described above, for some SFSR embodiments, patch indexing may be used for performing super-resolution. For the illustrated embodiment, the system 1100 comprises an encoder 1104, a patch extractor and classifier 1106, a reorder block 1110 and a patch database 1112. For some embodiments, the encoder 1104 and the patch extractor and classifier 1106 may correspond to the encoder 104 and metadata extractor 106 of FIG. 1, respectively.

The patch extractor and classifier 1106 may be configured to extract patches from uncompressed LR content 1120 and to classify the extracted patches as important patches 1122 or unimportant patches 1124. For example, the patch extractor and classifier 1106 may classify as important those patches that correspond to edges, foreground, moving objects or the like and may classify as unimportant those patches that correspond to smooth regions, weak structures or the like.

The patch extractor and classifier 1106 may also be configured to determine whether the important patches 1122 have a corresponding low-scored match 1126 in the patch database 1112 or a corresponding high-scored match 1128 in the patch database 1112. Important patches 1122 having a low-scored match 1126 and unimportant patches 1124 may be provided to the reorder block 1110 as patch content 1130. For important patches 1122 having a high-scored match 1128 in the patch database 1112, the patch number 1132 of the high-scored match 1128 may be provided to the reorder block 1110.

In this way, the encoder 1104 may simply encode the patch numbers 1132 for important patches 1122 having high-scored matches 1128 in the database 1112 and skip encoding the contents of those important patches 1122. Thus, for these embodiments, the encoder 1104 only encodes actual patch content for the important patches 1122 with low-scored matches 1126 and for the unimportant patches 1124. By inserting a downsampler before the encoding process and transmitting the patch numbers as metadata, the super-resolution processor can recover a high-quality image because the patch numbers are associated with high-resolution patches.

Although FIG. 11 illustrates one example of a system 1100 for providing super-resolution, various changes may be made to FIG. 11. For example, the makeup and arrangement of the system 1100 are for illustration only. Components could be added, omitted, combined, subdivided, or placed in any other suitable configuration according to particular needs.

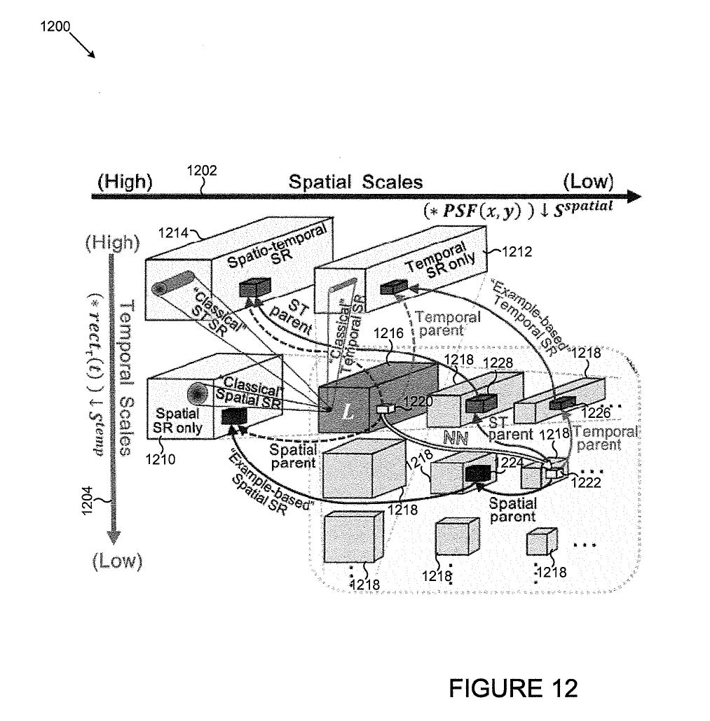

FIG. 12 illustrates a process 1200 for providing database-free super-resolution according to an embodiment of the disclosure. The process 1200 shown in FIG. 12 is for illustration only. A process for providing super-resolution may be implemented in any other suitable manner without departing from the scope of this disclosure.

As described above, for some SFSR embodiments, database-free super-resolution may be implemented. Improving both spatial and temporal resolutions of a video is feasible using a patch-based super-resolution approach through decomposing the video into 3D space-time (ST) patches. However, using an external database of natural videos to do this is impractical since a representative database of natural video sequences would be too large for a realistic implementation. Therefore, an approach has been suggested that includes leveraging internal video redundancies to implement a patch-based, space-time super-resolution approach based on the observation that small ST patches within a video are repeated many times inside the video itself at multiple spatio-temporal scales.

The illustrated system 1200 comprises a space-time pyramid with spatial scales 1202 and temporal scales 1204 decreasing from high to low as indicated in FIG. 12. Thus, for some embodiments, spatial super-resolution may be performed to generate a spatial SR output 1210, temporal super-resolution may be performed to generate a temporal SR output 1212, or spatio-temporal super-resolution may be performed to generate a spatio-temporal SR output 1214.

Blurring and sub-sampling an input video 1216 in space and in time generates a cascade of spatio-temporal resolutions 1218. Each input ST-patch 1220 searches for similar ST-patches 1222 in lower pyramid levels. Each matching ST-patch 1222 may have a spatial parent 1224, a temporal parent 1226, or a spatio-temporal parent 1228. The input ST-patch 1220 can be replaced by one of the parent patches 1224, 1226 or 1228 depending on the intention to improve spatial resolution, temporal resolution, or both resolutions. For these embodiments, the SR metadata may comprise, for each input ST-patch 1220 in the input video 1216, the addresses of similar patches 1222 in lower spatial/temporal scales.

For other embodiments using an SFSR metadata approach, super-resolution may be provided via sparse representation. For these embodiments, the image-encoding system may be configured to learn dictionaries from low-resolution and high-resolution patches of an image database. For example, for each low-resolution patch, L, the image-encoding system may be configured to compute a sparse representation in a low-resolution dictionary, D_{L}. For the corresponding high-resolution patch, H, the image-encoding system may be configured to compute a sparse representation in the high-resolution dictionary, D_{H}. The image-decoding system may also be configured to use the sparse coefficient of L to generate a high-resolution patch from the high-resolution dictionary. The image-encoding system may also be configured to learn a sparse representation for the difference between the original high-resolution patches and their (expected) high-resolution reconstructions from the corresponding low-resolution patches. Dictionaries can be learned in a two-step procedure. First, D_{H}, D_{L} can be jointly learned for the high- and low-resolution patches. Then, D_{M} is learned on the residuals in the reconstruction. The two-step dictionary learning procedure can be modeled as the following optimization problem:
Step 1) Learn dictionaries D_{H} and D_{L} that represent the given low- and high-resolution image patches, L and H, in terms of sparse vectors Z:

minimize_{{D}_{_{H}}_{,D}_{_{L}}_{,Z}}∥H−D_{H}Z∥₂²+∥L−D_{L}Z∥₂²+λ_{Z}∥Z∥₁.
Step 2) With fixed D_{H}, D_{L} and the corresponding Z values that were used in Step 1, learn a dictionary Dₘ:

minimize_{{D}_{_{M}}_{,M}}∥H−D_{H}Z−D_{M}M∥₂²+λ_{M}∥M∥₁.

D_{H}, D_{L}, Z are the optimization variables for the first step and D_{M}, M are the optimization variables for the second step. The term (D_{H}Z+D_{M}M) is a better approximation to H than the term D_{H}Z. The three dictionaries are learned in an offline process and encapsulated into the metadata extractor and super-resolution processor, where they will be used subsequently, without any modification.

To obtain metadata, the metadata extractor first solves the following optimization problem to determine a sparse representation for the low resolution image L:

Step a) minimize_{{Z}}∥L−D_{L}Z∥₂²+λ_{Z}∥Zλ₁.

Next, given Z, the metadata extractor approximates the high-resolution image as:

Step b) Ĥ [symbol] D_{H}Z.

Finally the metadata extractor constructs the metadata, M, by solving the following simplified form of the optimization problem at the encoder:

Step c) minimize_{M}∥H−ĤD_{M}M∥₂²+λ_{M}∥M∥₁.

The metadata M (dictionary coefficients) is transmitted to the super-resolution processor in the receiver. Given L, the super-resolution processor first repeats Step (a) to obtain Z. It then repeats Step (b) and uses Z to obtain Ĥ, a first approximation to H. Finally, the super-resolution processor uses Ĥ and the metadata M to obtain the final, close approximation to H given by (Ĥ+D_{M}M).

In another embodiment, the image-encoding system may be configured to generate low-resolution patches from high-resolution patches of the input image using a pre-defined down-sampling operator. The encoding system may also be configured to reconstruct high-resolution patches from the low-resolution patches using any suitable super-resolution scheme. For example, for each high-resolution patch, H, the image-encoding system may be configured to convert H into a low-resolution patch, L, and then reconstruct Ĥ. The image-decoding system may also be configured to use the same super-resolution scheme to generate high-resolution patches from the encoded low-resolution patches. The image-encoding system may also be configured to learn a sparse representation for the difference between the original high-resolution patches and their (expected) high-resolution reconstructions from the corresponding low-resolution patches. The dictionary for the residuals, D_{M}, may be learned using the difference between the original and the reconstructed high-resolution patches using the following optimization problem:

minimize_{{D}_{_{M}}_{,M}}∥H−Ĥ−D_{M}M∥₂²+λ_{M}∥M∥₁,

where D_{M}, M are the optimization variables. The term (Ĥ+D_{M}M) is a better approximation to H than is the term Ĥ. The dictionary is learned in an offline process and then encapsulated into the metadata extractor and super-resolution processor, where it will be used subsequently, without any modification.

To obtain metadata, the metadata extractor first applies a specific, pre-determined super-resolution method to reconstruct a high-resolution image, Ĥ, from the low resolution image L. Next, given Ĥ, the metadata extractor constructs metadata, M, by solving the following optimization problem at the encoder:

minimize_{M}∥H−Ĥ−D_{M}M∥₂²+λ_{M}∥M∥₁.

The metadata M (dictionary coefficients) is transmitted to the super-resolution processor in the receiver. Given L, the super-resolution processor first computes Ĥ using the pre-determined super-resolution scheme. It then uses Ĥ and the metadata M to obtain the final, close approximation to H given by (Ĥ+D_{M}M).

For other embodiments using an SFSR metadata approach, statistical wavelet-based SFSR may be implemented. For these embodiments, instead of filtering to estimate missing subbands, the image-encoding system may be configured to derive an interscale statistical model of wavelet coefficients and to transmit these statistics as metadata.

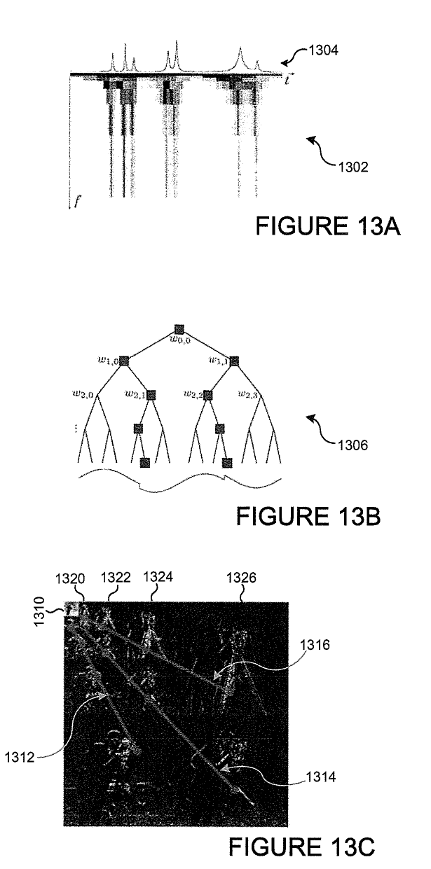

FIGS. 13A-C illustrate use of a tree-structured wavelet model for providing super-resolution according to an embodiment of the disclosure. The implementation shown in FIGS. 13A-C is for illustration only. Models may be used for super-resolution in any other suitable manner without departing from the scope of this disclosure.

As described above, for some SFSR embodiments, super-resolution may be provided using a tree-structured wavelet model. FIGS. 13A-C illustrate a particular example of this process. FIG. 13A illustrates frequencies 1302 present in a signal 1304, or image, over time. Edges in the signal 1304 correspond to higher frequencies. Sharp spikes in the signal 1304 indicate sharper edges, whereas more blunt spikes indicate less sharp edges. FIG. 13B illustrates a tree-structured wavelet model 1306 derived based on a wavelet transformation of the signal 1304. The wavelet transformation decomposes the signal 1304 into a low spatial scale and provides edge information at different scales.

FIG. 13C illustrates an image 1310 corresponding to the signal 1304 and the model 1306 at different scales of resolution for different types of edges. The original image 1310 is provided at a low spatial scale. From this original image 1310, three sets of edge information are provided: a horizontal edge set 1312, a diagonal edge set 1314, and a vertical edge set 1316. For the illustrated example, moving away from the original image 1310, each set 1312, 1314 and 1316 comprises four subsets of edge information: low resolution, mid-low resolution, mid-high resolution, and high resolution. For example, the vertical edge set 1316 comprises low resolution edge information 1320, mid-low resolution edge information 1322, mid-high resolution edge information 1324, and high resolution edge information 1326. Higher resolution edge information corresponds to stronger edge information, while lower resolution edge information corresponds to weaker edge information.

For these embodiments, the image-encoding system may be configured to derive a statistical model 1306 for the wavelet coefficients. The model 1306 may be derived based on clustering, i.e., active/significant wavelet coefficients are clustered around edges in a scene, and based on persistence, i.e., active/significant wavelet coefficients have strong correlations across scales. Thus, using a wavelet transformation of a high-resolution image, a statistical model 1306 may be derived that captures the dependencies as illustrated in FIGS. 13A-C.

As illustrated in FIG. 13B, the hidden Markov tree model (HMM) 1306 with a mixture of Gaussians may be used for this purpose. However, it will be understood that any suitable model may be used without departing from the scope of this disclosure. The image-encoding system may be configured to transmit the parameters of the statistical model 1306 as metadata. For example, the metadata may comprise HMM parameters that characterize the tree structure of each image, HMM parameters that characterize correlation/variations of wavelet coefficients in adjacent images, or the like. In addition, the image-encoding system may also be configured to train a model for wavelet coefficients of a single image or a group of images. The image-decoding system may be configured to enforce the statistical model 1306 during high-resolution image recovery.

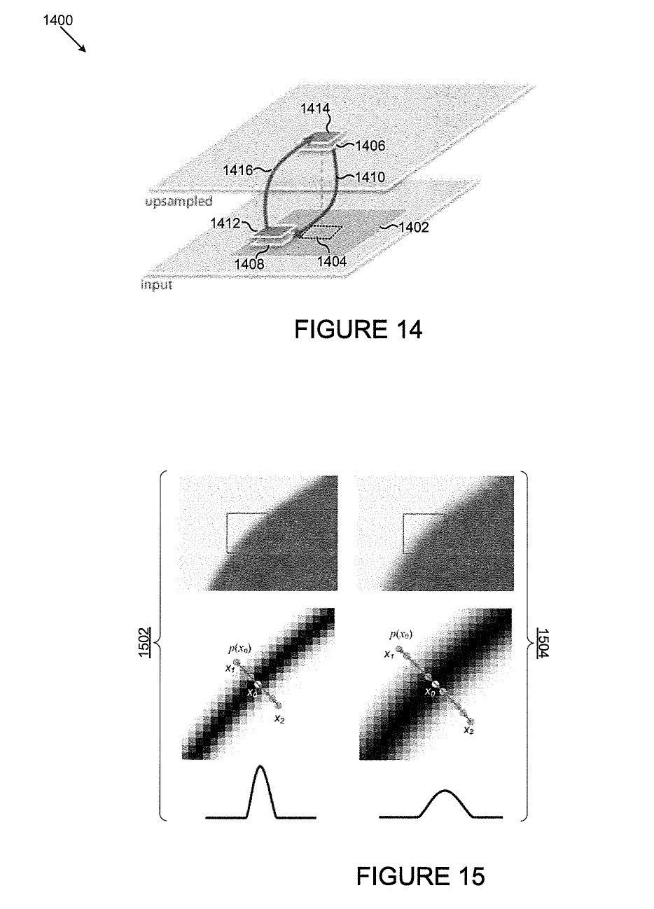

FIG. 14 illustrates a process 1400 for providing super-resolution using non-dyadic, interscale, wavelet patches according to an embodiment of the disclosure. The process 1400 shown in FIG. 14 is for illustration only. A process for providing super-resolution may be implemented in any other suitable manner without departing from the scope of this disclosure.

As described above, for some SFSR embodiments, non-dyadic, interscale, wavelet patches may be used to provide super-resolution. Patch-based methods generally use a patch database, which can be impractical due to storage issues and time issues associated with searching the database. Therefore, for some embodiments, the super-resolution process may use patches without using a patch database. For some embodiments, this may be accomplished by locating the patches within the low-resolution image itself by exploiting self-similarity over scale. In this way, there are no storage issues for a database and search time is relatively low because the search window is small. The self-similarity over scale assumptions holds for small (non-dyadic) scale factors, e.g., 5/4, 4/3, 3/2 or the like. Thus, this is fundamentally different from current non-patch-based approaches that use the dyadic scale factors 2 and 4 and that assume a parameterized Gaussian filter will generate a higher scale from a lower scale.

For the example illustrated in FIG. 14, an upscaling scheme is implemented. A patch of lower-frequency bands from an upsampled image is matched with its nearest patch within a small window in the low-passed input image. The upper-frequency band of the matched patch in the input is used to fill in the missing upper band in the output upsampled image. More specifically, for this example, a low-resolution input image 1402 comprises an original patch I₀ 1404. The original patch I₀ 1404 is upsampled to generate an upsampled patch L₁ 1406. The input image 1402 is then searched for a close match to the upsampled patch L₁ 1406. A smoothed patch L₀ 1408 is found as a match for L₁ 1406, as indicated by a first patch translation vector 1410. Next, complementary high-frequency content H₀ 1412 is calculated as follows:

H₀=I₀−L₀.

Thus, the high-frequency content H₀ 1412 corresponds to the difference between the original patch I₀ 1404 and the smoothed patch L₀ 1408, which has low-frequency content. Finally, the high-frequency content H₀ 1412 is upsampled to generate a super-resolution (SR) output 1414, as indicated by a second patch translation vector 1416. The SR output 1414 is calculated as follows:

SR output=L₁+H₀.

Thus, the SR output 1414 corresponds to the upsampled patch L₁ 1406 added to the high-frequency content H₀ 1412.

For these embodiments, the metadata may comprise patch translation vectors that show the translations between best-matching patches, such as the first patch translation vector 1410 or the second patch translation vector 1412. Alternatively, the metadata may comprise patch corrections, which include differences between patch translation vectors calculated at the image-encoding system and the image-decoding system.

FIG. 15 illustrates edge profile enhancement for use in providing super-resolution according to an embodiment of the disclosure. The edge profile enhancement shown in FIG. 15 is for illustration only. Edge profile enhancement may be implemented in any other suitable manner without departing from the scope of this disclosure.

As described above, for some SFSR embodiments, edge profile enhancement may be used to provide super-resolution. The human visual system is more sensitive to edges than smooth regions in images. Thus, image quality (but not resolution) can be improved simply based on the enhancement of strong edges. A parametric prior learned from a large number of natural images can be defined to describe the shape and sharpness of image gradients. Then a better quality image can be estimated using a constraint on image gradients. In another approach, the output image is directly estimated by redistributing the pixels of the blurry image along its edge profiles. This estimation is performed in such a way that anti-aliased step edges are produced.

A sharper-edge profile 1502 and a blunter-edge profile 1504 are illustrated in FIG. 15. For some embodiments, the image-encoding system may be configured to transmit, as metadata, the Generalized Gaussian Distribution (GGD) variance, σ, for selected edges. For other embodiments, the image-encoding system may be configured to transmit, as metadata, the GGD shape parameter, λ, for selected edges. Also, for some embodiments, one set of GGD parameters may be estimated to be used for multiple images. However, for other embodiments, GGD parameters may be estimated for each image.

For some embodiments, the image-encoding system may be configured to detect edges from a low-resolution image after downsampling. Based on a corresponding high-resolution image before downsampling, the image-encoding system may be configured to determine edge-profile parameters for the detected edges. For example, the image-encoding system may be configured to determine a maximum pixel value and a minimum pixel value for each detected edge. These parameters may be used to characterize the corresponding edge.

The image-encoding system may be configured to transmit these edge-profile parameters as metadata. This will allow more accurate pixel re-distribution for high-resolution edge reconstruction. Also, for some embodiments, the image-encoding system may be configured to transmit downsampling filter coefficients as metadata to improve the estimation of the high-resolution image from the low-resolution image.

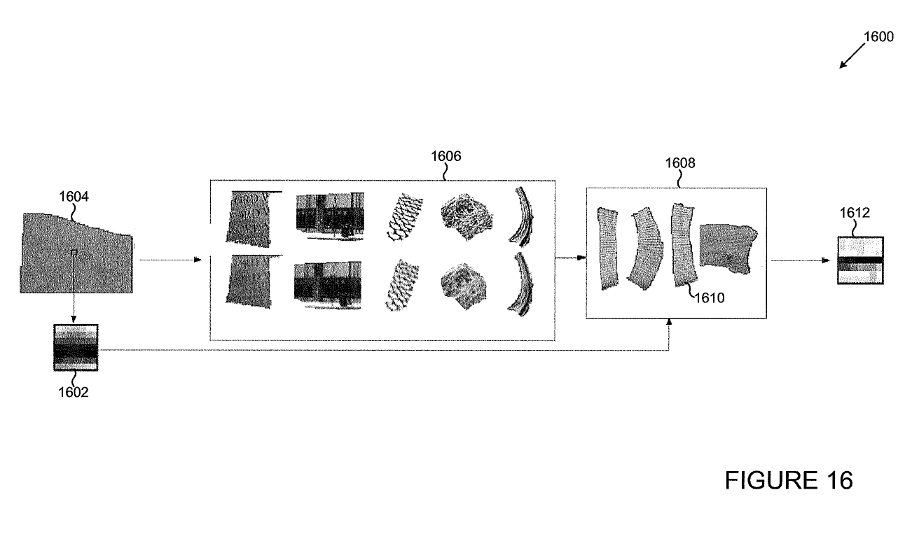

FIG. 16 illustrates a process 1600 for providing super-resolution using hallucination according to an embodiment of the disclosure. The process 1600 shown in FIG. 16 is for illustration only. A process for providing super-resolution may be implemented in any other suitable manner without departing from the scope of this disclosure.

As described above, for some SFSR embodiments, super-resolution may be provided using a hallucination technique. As a particular example of this process 1600, a low-resolution segment 1602 of a low-resolution input image 1604 is compared against low-resolution segments in a training database 1606. The training database 1606 comprises a large number of high-resolution/low-resolution pairs of segments. Based on the search, a specified number of the most texturally similar low-resolution segments 1608 in the database 1606 may be identified and searched to find the best matching segment 1610 for the low-resolution segment 1602. For some embodiments, the specified number may be 10; however, it will be understood that any suitable number of most texturally similar segments may be identified without departing from the scope of the disclosure. Finally, a high-resolution segment 1612 is hallucinated by high-frequency detail mapping from the best matching segment 1610 to the low-resolution segment 1602.

Thus, for some embodiments, the image-encoding system may be configured to identify a best matching segment 1610 and to transmit metadata identifying the best matching segment 1610 as metadata. For some embodiments, the low-resolution segments 1608 may be grouped into clusters and the metadata identifying the best matching segment 1610 may be used to identify the cluster including the best matching segment 1610. In this way, the metadata may identify the cluster based on one segment 1610 instead of using additional overhead to identify each segment in the cluster.

For a particular embodiment, the identified segments 1608 may be normalized to have the same mean and variance as the low-resolution segment 1602. The following energy function is minimized to obtain a high-resolution segment 1612 corresponding to the low-resolution segment 1602:

E(I^{h})=E(I^{h}|I^{l})+β₁Eₕ(I^{h})+β₂Eₑ(I^{h}),

where I^{h} is the high-resolution segment 1612, I^{l} is the low-resolution segment 1602, and β₁ and β₂ are coefficients.

The first energy term E(I^{h}|I^{l}) is a high-resolution image reconstruction term that forces the down-sampled version of the high-resolution segment 1612 to be close to the low-resolution segment 1602. The high-resolution image reconstruction term is defined as follows:

E(I^{h}|I^{l})=|(I^{h}*G)↓−I^{l}|²,

where G is a Gaussian kernel and ↓ indicates a downsampled version of the corresponding segment.

The second energy term Eₕ(I^{h}) is a hallucination term that forces the value of pixel p in high-resolution image I^{h} to be close to hallucinated candidate examples learned by the image-encoding system. The hallucination term is defined as follows:

$${E}_{h} ( {I}^{h} ) = {\sum }_{p} {min}_{i} \{ {( {I}^{h} ( p ) - {c}_{i} ( p ) )}^{2} \} ,$$

where cᵢ is the i^{th} candidate example.

The third energy term Eₑ(I^{h}) is an edge-smoothness term that forces the edges of the high-resolution image to be sharp. The edge-smoothness term is defined as follows:

$${E}_{e} ( {I}^{h} ) = - {\sum }_{p} \{ {p}_{b} ( p ) \cdot {\sum }_{k = 1}^{4} {α}_{k} log [ 1 + \frac{1}{2} {( {f}_{k} * {I}^{h} ( p ) )}^{2} ] \} ,$$

where p_{b} is a probability boundary computed by color gradient and texture gradient, αₖ is the k^{th} distribution parameter, and fₖ is the k^{th} filter.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses may be performed by more, fewer, or other components. The methods may include more, fewer, or other steps. Additionally, steps may be combined and/or performed in any suitable order.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An image-encoding system configured to generate an output stream based on an input image, comprising:
an encoder configured to encode a low-resolution image to generate a quantized, low-resolution image, wherein the low-resolution image is generated based on the input image; and
a metadata extractor configured to extract super-resolution (SR) metadata from the input image, wherein the output stream comprises the quantized, low-resolution image and the SR metadata.

2. The image-encoding system of claim 1, further comprising a pre-processing block configured to perform pre-processing on the input image to generate the low-resolution image.

3. The image-encoding system of claim 1, further comprising:
a pre-processing block configured to perform pre-processing on the input image to generate a processed image; and
a downsampler configured to downsample the processed image to generate the low-resolution image.

4. The image-encoding system of claim 1, further comprising a down converter configured to down convert the input image to generate the low-resolution image, and wherein the encoder is further configured to encode the SR metadata with the low-resolution image to generate the output stream.

5. A method for generating an output stream based on an input image, comprising:
encoding a low-resolution image to generate a quantized, low-resolution image, wherein the low-resolution image is generated based on the input image;
extracting super-resolution (SR) metadata from the input image; and
generating the output stream based on the quantized, low-resolution image and the SR metadata.

6. The method of claim 5, wherein the SR metadata comprises motion information.

7. The method of claim 5, wherein the SR metadata comprises downsampling information.

8. The method of claim 5, wherein the SR metadata comprises camera parameters.

9. The method of claim 5, wherein the SR metadata comprises at least one of a blurring filter, a database of spatio-temporal patches, patch numbers, dictionary coefficients, statistical parameters, patch-translation vectors, edge-characterization parameters, best-matching segments, long-term reference frame numbers corresponding to frames including an object that has been occluded in adjacent frames, and displacement of salient feature points.

10. The method of claim 5, further comprising encapsulating the metadata using one of network abstraction layer unit (NALU) and supplemental enhancement information (SEI).

11. An image-decoding system configured to receive an output stream comprising a quantized, low-resolution image and SR metadata, wherein the quantized, low-resolution image is generated based on an input image, and wherein the SR metadata is extracted from the input image, the image-decoding system comprising:
a decoder configured to decode the quantized, low-resolution image to generate a decoded image; and
a super-resolution processor configured to perform super-resolution on the decoded image based on the SR metadata to generate a super-resolved image.

12. The image-decoding system of claim 11, wherein the SR metadata comprises at least one of motion information, downsampling information, camera parameters, a blurring filter, a database of spatio-temporal patches, patch numbers, dictionary coefficients, statistical parameters, patch-translation vectors, edge-characterization parameters, best-matching segments, long-term reference frame numbers corresponding to frames including an object that has been occluded in adjacent frames, and displacement of salient feature points.

13. The image-decoding system of claim 11, wherein the SR metadata is encapsulated using one of NALU and SEI.

14. A method for providing super-resolution of quantized images, comprising:
receiving an output stream comprising a quantized, low-resolution image and SR metadata, wherein the quantized, low-resolution image is generated based on an input image, and wherein the SR metadata is extracted from the input image;
decoding the quantized, low-resolution image to generate a decoded image; and
performing super-resolution on the decoded image based on the SR metadata to generate a super-resolved image.

15. The method of claim 14, wherein the SR metadata comprises motion information.

16. The method of claim 14, wherein the SR metadata comprises downsampling information.

17. The method of claim 14, wherein the SR metadata comprises camera parameters.

18. The method of claim 14, wherein the SR metadata comprises at least one of a blurring filter, a database of spatio-temporal patches, patch numbers, dictionary coefficients, statistical parameters, patch-translation vectors, edge-characterization parameters, best-matching segments, long-term reference frame numbers corresponding to frames including an object that has been occluded in adjacent frames, and displacement of salient feature points.

19. The method of claim 14, wherein the SR metadata is encapsulated using one of NALU and SEI.

20. The method of claim 14, wherein the super-resolved image comprises a higher resolution than the input image.
